(19) United States
(12) Patent Application Publication
(10) Pub. No.: US 2022/0266687 A1
(43) Pub. Date: Aug. 25, 2022

(54) VEHICLE DRIVE DEVICE

(71) Applicant: TOYOTA JIDOSHA KABUSHIKI KAISHA, Toyota-shi (JP)

(72) Inventors: Atsushi TABATA, Okazaki-shi (JP); Koichi OKUDA, Toyota-shi (JP); Koji TAKAIRA, Okazaki-shi (JP); Akinori HOMAN, Toyota-shi (JP); Yosuke AKIYAMA, Susono-shi (JP); Akira IJICHI, Odawara-shi (JP); Kunihiko USUI, Fuji-shi (JP)

(73) Assignee: TOYOTA JIDOSHA KABUSHIKI KAISHA, Toyota-shi (JP)

(21) Appl. No.: 17/673,981

(22) Filed: Feb. 17, 2022

(30) Foreign Application Priority Data
Feb. 22, 2021 (JP) 2021-026802

(51) Int. Cl. B60K 17/346; F16H 48/36

(52) U.S. Cl. CPC B60K 17/3462; F16H 48/36; F16H 2048/364

(57) ABSTRACT

A vehicle drive device includes a differential mechanism provided with a first rotating element connected to the first output shaft, a second rotating element connected to the second output shaft, and a third rotating element connected to the rotating electric machine and an engaging element that selectively engages any two of the first rotating element, the second rotating element, and the third rotating element. A control device controls torque from a rotating electric machine so as to change a torque distribution ratio at which torque from a power source is distributed to the first output shaft and the second output shaft, and changes the torque distribution ratio by controlling a torque capacity of the engaging element when the torque from an rotating electric machine is limited and thus a change in the torque distribution ratio is restricted.

### CROSS-REFERENCE TO RELATED APPLICATION

This application claims priority to Japanese Patent Application No. 2021-026802 filed on Feb. 22, 2021, incorporated herein by reference in its entirety.

### BACKGROUND

### 1. Technical Field

The present disclosure relates to a vehicle drive device.

### 2. Description of Related Art

Japanese Unexamined Patent Application Publication No. 2007-246056 (JP 2007-246056 A) discloses a vehicle drive device including a power source, a rotating electrical machine, a first output shaft, a second output shaft, and a differential mechanism. The first output shaft is connected to the power source and outputs power to one of front wheels and rear wheels. The second output shaft outputs power to the other of the front wheels and the rear wheels. The differential mechanism includes a first rotating element connected to the first output shaft, a second rotating element connected to the second output shaft, and a third rotating element connected to the rotating electric machine. The vehicle drive device is configured to change a torque distribution ratio at which torque from the power source is distributed to the first output shaft and the second output shaft by controlling the torque from the rotating electric machine. Note that, the vehicle drive device disclosed in JP 2007-246056 A includes a differential limiting clutch that engages any two of the first rotating element, the second rotating element, and the third rotating element. The differential limiting clutch is engaged to enable electric vehicle (EV) traveling by the rotating electric machine.

### SUMMARY

When the torque from the rotating electric machine is controlled so as to change the torque distribution ratio at which the torque is distributed to the first output shaft and the second output shaft, there is an issue that a change of the torque distribution ratio is restricted due to limitation of the torque from the rotating electric machine such as limitation of torque from the rotating electric machine due to a state-of-charge (SOC) of a battery or limitation of torque from the rotating electric machine due to an increase of a temperature of the rotating electric machine.

The present disclosure has been made in view of the above issue, and an object of the present disclosure is to provide a vehicle drive device capable of appropriately changing the torque distribution ratio at which the torque from the power source is distributed to the first output shaft and the second output shaft.

In order to solve the above-mentioned issue and achieve the object, a vehicle drive device according to the present disclosure includes: a power source; a rotating electric machine; a first output shaft that is connected to the power source and outputs power to one of front wheels and rear wheels; a second output shaft that outputs power to the other of the front wheels and the rear wheels; a differential mechanism provided with a first rotating element connected to the first output shaft, a second rotating element connected to the second output shaft, and a third rotating element connected to the rotating electric machine; an engaging element that selectively engages any two of the first rotating element, the second rotating element, and the third rotating element; and control device. The control device is configured to control torque from the rotating electric machine so as to change a torque distribution ratio at which torque from the power source is distributed to the first output shaft and the second output shaft, and to change the torque distribution ratio by controlling a torque capacity of the engaging element when the torque from the rotating electric machine is limited and thus a change of the torque distribution ratio is restricted.

Accordingly, with the vehicle drive device according to the present disclosure, even when the torque from the rotating electric machine is limited, and the change of the torque distribution ratio at which the torque is distributed to the first output shaft and the second output shaft is restricted, the torque distribution ratio can be appropriately changed by controlling the torque capacity of the engaging element.

Further, in the above configuration, the control device may be configured to change the torque distribution ratio by controlling the torque capacity of the engaging element when the torque from the rotating electric machine is limited and the torque distribution ratio is not able to be changed to a required torque distribution ratio.

With this configuration, when the torque from the rotating electric machine is limited, and the torque distribution ratio at which the torque is distributed to the first output shaft and the second output shaft cannot be changed to the torque distributed, the torque distribution ratio can be appropriately changed by controlling the torque capacity of the engaging element.

Further, in the above configuration, the first output shaft and the first rotating element may be connected to each other so as to be disconnectable and connectable by a disconnection-connection mechanism, and the vehicle drive device may further include a fixing element that selectively fixes the first rotating element to a fixing member.

With this configuration, the differential mechanism is in a directly connected state in which the first rotating element, the second rotating element, and the third rotating element rotate integrally, while the power from the rotating electric machine can be transferred to the second output shaft, and the power from the rotating electric machine can be transferred to the second output shaft in a speed reduction state in which the first rotating element is fixed to the fixing member in the differential mechanism.

Further, in the above configuration, the second output shaft and the second rotating element may be connected to each other so as to be disconnectable and connectable by a disconnection-connection mechanism, and the vehicle drive device may further include a fixing element that selectively fixes the second rotating element to a fixing member.

With this configuration, the differential mechanism is in a directly connected state in which the first rotating element, the second rotating element, and the third rotating element rotate integrally, while the power from the rotating electric machine can be transferred to the first output shaft, and the power from the rotating electric machine can be transferred to the first output shaft in a speed reduction state in which the second rotating element is fixed to the fixing member in the differential mechanism.

The vehicle drive device according to the present disclosure, the effect that the torque distribution ratio can be appropriately changed by controlling the torque capacity of the engaging element can be achieved even when the torque from the rotating electric machine is limited, and the change of the torque distribution ratio at which the torque is distributed to the first output shaft and the second output shaft is restricted.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing a schematic configuration of a vehicle provided with a drive device according to a first embodiment;

FIG. 2 is a diagram illustrating a main portion of a control system for various controls in the drive device according to the first embodiment;

FIG. 3 is a diagram illustrating a schematic configuration of a compound transmission according to the first embodiment;

FIG. 4 is a diagram illustrating the relationship of the combination between the AT gear stage of a stepped transmission unit and the operation of an engaging device;

FIG. 5 is a diagram showing an example of a shift map used for shift control of the stepped transmission unit;

FIG. 6 is a diagram showing an example of a power source switching map used in switching control between an electronic vehicle (EV) traveling mode and an engine traveling mode;

FIG. 7 is a skeleton diagram schematically showing a transfer according to the first embodiment, and is a skeleton diagram showing a case where the transfer is in a first driving state;

FIG. 8 is a diagram showing the engagement relationship of each rotating member in the transfer according to the first embodiment;

FIG. 9 is a diagram showing the relationship between each of the drive states of the transfer and an operating state of each engaging device;

FIG. 10 is a skeleton diagram showing a case where the transfer according to the first embodiment is in a second drive state;

FIG. 11 is a skeleton diagram showing a case where the transfer according to the first embodiment is in a third drive state;

FIG. 12 is a skeleton diagram showing a case where the transfer according to the first embodiment is in a fourth drive state;

FIG. 13 is a skeleton diagram showing a case where the transfer according to the first embodiment is in a fifth drive state;

FIG. 14 is a skeleton diagram showing a case where the transfer according to the first embodiment is in a sixth drive state;

FIG. 15 is a diagram showing the relationship between output torque from a third rotating electric machine, and a torque distribution ratio on the rear wheel side;

FIG. 16 is a flowchart showing an example of control executed by an electronic control device of the vehicle according to the first embodiment;

FIG. 17 is a skeleton diagram schematically showing the transfer according to the second embodiment, and is a skeleton diagram showing a case where the transfer is in the first drive state;

FIG. 18 is a diagram showing the engagement relationship of each rotating member in the transfer according to the second embodiment;

FIG. 19 is a diagram showing the relationship between each of the drive states of the transfer according to the second embodiment and an operating state of each engaging device;

FIG. 20 is a skeleton diagram showing a case where the transfer according to the second embodiment is in the second drive state;

FIG. 21 is a skeleton diagram showing a case where the transfer according to the second embodiment is in the third drive state;

FIG. 22 is a skeleton diagram showing a case where the transfer according to the second embodiment is in the fourth drive state;

FIG. 23 is a skeleton diagram showing a case where the transfer according to the second embodiment is in the fifth drive state; and

FIG. 24 is a skeleton diagram showing a case where the transfer according to the second embodiment is in the sixth drive state.

### DETAILED DESCRIPTION OF EMBODIMENTS

### First Embodiment

A first embodiment of a vehicle drive device according to the present disclosure will be described below. Note that, an applicable embodiment of the present disclosure is not limited to the present embodiment.

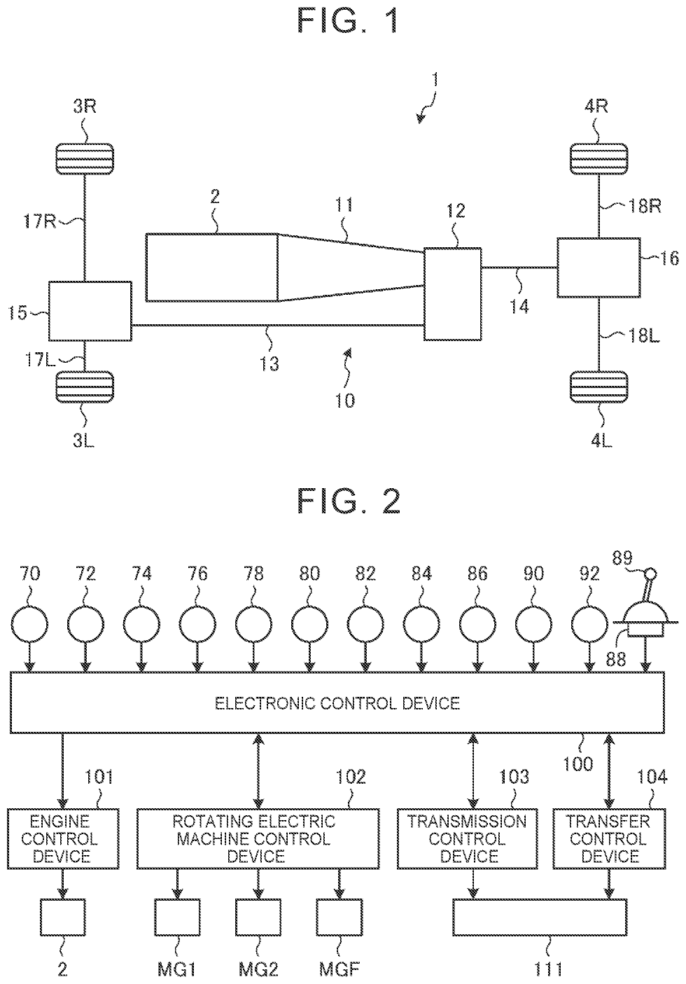

FIG. 1 is a diagram showing a schematic configuration of a vehicle 1 provided with a drive device 10 according to the first embodiment. The vehicle 1 includes right and left front wheels 3R, 3L, right and left rear wheels 4R, 4L, and the drive device 10 that transfers power (torque) from an engine 2 as a first power source to the right and left front wheels 3R, 3L and the right and left rear wheels 4R, 4L. This vehicle 1 is a four-wheel drive vehicle based on front-engine, rear-wheel-drive layout.

The drive device 10 includes the engine 2, a compound transmission 11 connected to the engine 2, a transfer 12 that is a front-rear wheel power distribution device connected to the compound transmission 11, and a front propeller shaft 13 and a rear propeller shaft 14 that are both connected to the transfer 12, a front-wheel differential gear mechanism 15 connected to the front propeller shaft 13, a rear-wheel differential gear mechanism 16 connected to the rear propeller shaft 14, right and left front wheel axles 17R, 17L connected to the front-wheel differential gear mechanism 15, right and left rear wheel axles 18R, 18L connected to the rear-wheel differential gear mechanism 16. Note that, when the right and left of the wheels and the wheel axles are not particularly differentiated from each other, reference signs R and L are omitted, and the terms are described as the front wheels 3, the rear wheels 4, the front wheel axles 17, and the rear wheel axles 18.

The engine 2 is a known internal combustion engine such as a gasoline engine or a diesel engine. In the engine 2, engine torque that is the output torque from the engine 2 is controlled by controlling an engine control device 101 such as a throttle actuator, a fuel injection device, and an ignition device provided in the engine 2 by an electronic control device 100 that will be described later.

The power output from the engine 2 is transferred to the transfer 12 via the compound transmission 11. Then, the power transferred to the transfer 12 is sequentially transferred from the transfer 12 to the rear wheels 4 via the rear propeller shaft 14, the rear-wheel differential gear mechanism 16, and the rear wheel axles 18 that constitute a power transfer path on the rear wheel side. A part of the power transferred to the transfer 12 is distributed to the front wheels 3 by the transfer 12, and is transferred to the front wheels 3 via the front propeller shaft 13, the front-wheel differential gear mechanism 15, and the front wheel axles 17 that constitute a power transfer path on the front wheel side. Unless otherwise specified, the power has the same meaning as the torque and the force.

As shown in FIG. 2, the drive device 10 includes the electronic control device 100. The electronic control device 100 includes, for example, a so-called microcomputer provided with a central processing unit (CPU), a random access memory (RAM), a read-only memory (ROM), and an input and output interface. The CPU executes various controls by executing signal processing in accordance with a program stored in the ROM in advance while using a transitory storage function of the RAM.

Output signals from various sensors and switches provided in the vehicle 1 (for example, an engine speed sensor 70, an output rotational speed sensor 72, an MG1 rotational speed sensor 74, an MG2 rotational speed sensor 76, an accelerator operation amount sensor 78, a throttle valve opening degree sensor 80, a battery sensor 82, an oil temperature sensor 84, a four-wheel-drive (4WD) selection switch 86, a shift position sensor 88 of a shift lever 89, a Low selection switch 90, and a Lock selection switch 92) and the like are input to the electronic control device 100. Further, the electronic control device 100 calculates a state-of-charge value SOC [%] as a value indicating a charge state of the battery based on, for example, charge and discharge current and a battery voltage of the battery that is a power storage device.

The electronic control device 100 outputs various command signals (for example, an engine control command signal for controlling the engine 2, a rotating electric machine control command signal for controlling a first rotating electric machine MG1, a second rotating electric machine MG2, and a third rotating electric machine MGF, and a hydraulic control command signal for controlling a hydraulic pressure of a hydraulic control circuit 111 that controls operating states of engaging devices of the compound transmission 11 and engaging devices of the transfer 12) to the respective devices provided in the vehicle 1 (for example, the engine control device 101, a rotating electric machine control device 102, a transmission control device 103, and a transfer control device 104).

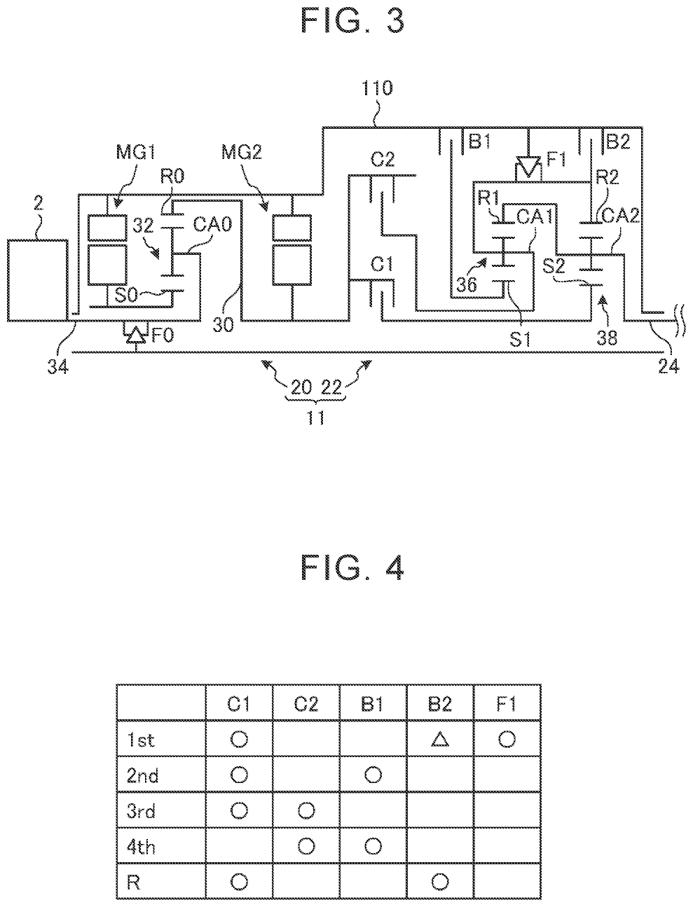

FIG. 3 is a diagram illustrating a schematic configuration of the compound transmission 11 according to the first embodiment.

The first rotating electric machine MG1 and the second rotating electric machine MG2 are rotating electric machines having a function as a motor and a function as a generator, and are so-called motor generators. The first rotating electric machine MG1 and the second rotating electric machine MG2 function as a power source for traveling capable of generating drive torque. The first rotating electric machine MG1 and the second rotating electric machine MG2 are each connected to the battery (not shown) as a power storage device provided in the vehicle 1 via an inverter (not shown) provided in the vehicle 1. The rotating electric machine control device 102 controls the inverter so as to control MG1 torque and MG2 torque that are the output torques from the first rotating electric machine MG1 and the second rotating electric machine MG2, respectively. The output torque from the rotating electric machine is power running torque in the positive torque on the acceleration side and regenerative torque in the negative torque on the deceleration side. The battery is a power storage device that supplies and receives electric power to and from each of the first rotating electric machine MG1 and the second rotating electric machine MG2. Therefore, the vehicle 1 is a hybrid vehicle.

The compound transmission 11 is provided with a continuously variable transmission unit 20 that is an electric differential unit and a stepped transmission unit 22 that is a mechanical transmission. The continuously variable transmission unit 20 and the stepped transmission unit 22 are disposed in series on a common axis in a transmission case 110 as a non-rotating member attached to a vehicle body. The continuously variable transmission unit 20 is directly or indirectly connected to the engine 2 via a damper (not shown) or the like. The stepped transmission unit 22 is connected to the output side of the continuously variable transmission unit 20. Further, an output shaft 24 that is an output rotating member of the stepped transmission unit 22 is connected to the transfer 12. In the drive device 10, the power output from the engine 2 is transferred to the stepped transmission unit 22, and is transferred from the stepped transmission unit 22 to the drive wheels via the transfer 12 and the like. Further, the continuously variable transmission unit 20, the stepped transmission unit 22, and the like are configured substantially symmetrically with respect to the common axis, and the lower half of the axis is omitted in FIG. 3. The common axis above is the axis of the crankshaft of the engine 2, a connecting shaft 34, and the like.

The continuously variable transmission unit 20 is provided with the first rotating electric machine MG1 and a differential mechanism 32. The differential mechanism 32 is a power split mechanism that mechanically splits the power from the engine 2 to the first rotating electric machine MG1 and an intermediate transfer member 30 that is an output rotating member of the continuously variable transmission unit 20. The second rotating electric machine MG2 is connected to the intermediate transfer member 30 such that power can be transferred to the second rotating electric machine MG2. The continuously variable transmission unit 20 is an electric differential unit in which the differential state of the differential mechanism 32 is controlled by controlling the operating state of the first rotating electric machine MG1. The continuously variable transmission unit 20 is operated as an electric continuously variable transmission in which a gear ratio that is a value of the ratio of the engine speed to an MG2 rotational speed is variable. The engine speed has the same value as a rotational speed of the connecting shaft 34 serving as an input rotating member. The MG2 rotational speed is a rotational speed of the intermediate transfer member 30 serving as an output rotating member.

The differential mechanism 32 is configured by a single pinion type planetary gear device, and includes a sun gear S0, a carrier CA0, and a ring gear R0. The engine 2 is connected to the carrier CA0 via the connecting shaft 34 such that power can be transferred. The first rotating electric machine MG1 is connected to the sun gear S0 such that power can be transferred. The second rotating electric machine MG2 is connected to the ring gear R0 such that power can be transferred. In the differential mechanism 32, the carrier CA0 functions as an input element, the sun gear S0 functions as a reaction force element, and the ring gear R0 functions as an output element.

The stepped transmission unit 22 is a mechanical transmission unit serving as a stepped transmission constituting a part of a power transfer path between the intermediate transfer member 30 and the transfer 12, that is, a mechanical transmission unit constituting a part of the power transfer path between the continuously variable transmission unit 20 and the transfer 12. The intermediate transfer member 30 also functions as an input rotating member of the stepped transmission unit 22. The stepped transmission unit 22 is an automatic transmission (AT) of a known planetary gear type that includes, for example, a plurality of sets of planetary gear devices composed of a first planetary gear device 36 and a second planetary gear device 38, and a plurality of engaging devices of a clutch C1, a clutch C2, a brake B1, and a brake B2, including a one-way clutch F1. Hereinafter, the clutch C1, the clutch C2, the brake B1, and the brake B2 are simply referred to as an engaging device unless specifically distinguished.

The engaging device is a hydraulic friction engaging device configured by a multi-plate or single plate clutch or brake pressed by a hydraulic actuator, a band brake tightened by the hydraulic actuator, or the like. An operating state of the engaging device is switched between operating states such as engagement and disengagement by each of hydraulic pressures as adjusted predetermined hydraulic pressures output from the hydraulic control circuit 111 provided in the vehicle 1.

In the stepped transmission unit 22, the rotating elements of the first planetary gear device 36 and the second planetary gear device 38 are partially connected to each other or each connected to the intermediate transfer member 30, the transmission case 110, or the output shaft 24 directly or indirectly via the engaging device or the one-way clutch F1. Each rotating element of the first planetary gear device 36 includes a sun gear S1, a carrier CA1, and a ring gear R1, and each rotating element of the second planetary gear device 38 includes a sun gear S2, a carrier CA2, and a ring gear R2.

The stepped transmission unit 22 is a stepped transmission in which any of a plurality of shift stages (also referred to as gear stages) among the gear stages having gear ratios (=AT input rotational speed/output rotational speed) that differ depending on, for example, engagement of a predetermined engaging device that is any of the engaging devices. That is, in the stepped transmission unit 22, the gear stage is switched, that is, speed change is executed, by selectively engaging the engaging devices. The stepped transmission unit 22 is a stepped automatic transmission in which each of a plurality of gear stages is formed. In the first embodiment, the gear stage formed by the stepped transmission unit 22 is referred to as an AT gear stage. The AT input rotational speed is the input rotational speed of the stepped transmission unit 22 that is the rotational speed of the input rotating member of the stepped transmission unit 22, and has the same value as the rotational speed of the intermediate transfer member 30. Further, the AT input rotational speed has the same value as the MG2 rotational speed that is the rotational speed of the second rotating electric machine MG2. The AT input rotational speed can be expressed by the MG2 rotational speed. The output rotational speed is the rotational speed of the output shaft 24 that is the output rotational speed of the stepped transmission unit 22, and is also the output rotational speed of the compound transmission 11 that is the entire transmission in which the continuously variable transmission unit 20 and the stepped transmission unit 22 are combined. The compound transmission 11 is a transmission constituting a part of the power transfer path between the engine 2 and the transfer 12.

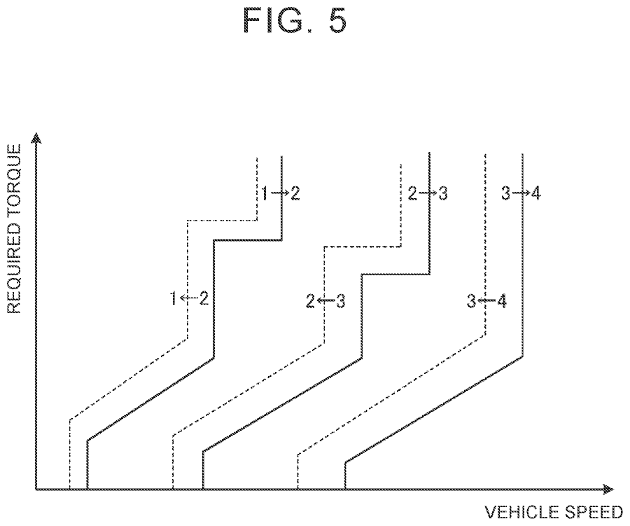

FIG. 4 is a diagram illustrating the relationship of the combination between the AT gear stage of the stepped transmission unit 22 and the operation of an engaging device CB. In FIG. 4, a white circle indicates engagement, a while triangle indicates engagement as needed, and blank indicates disengagement. As shown in FIG. 4, for example, the stepped transmission unit 22 has four forward AT gear stages from the AT first gear stage (“1st” in FIG. 4) to the AT fourth gear stage (“4th” in FIG. 4) and a reverse AT gear stage (“R” in FIG. 4), as a plurality of the AT gear stages. The gear ratio of the AT first gear stage is the largest, and the gear ratio becomes smaller as the AT gear stage is on the higher side.

In the stepped transmission unit 22, the electronic control device 100 selectively switches the AT gear stage formed in accordance with an operation of an accelerator pedal by a driver, a vehicle speed, or the like, that is, selectively forms the AT gear stages. For example, in shift control of the stepped transmission unit 22, the shifting is executed by switching engagement of any of the engaging devices, that is, so-called clutch-to-clutch shifting is executed in which the shifting is executed by switching between engagement and disengagement of the engaging devices. In the first embodiment, for example, downshift from the AT second gear stage to the AT first gear stage is represented as a 2→1 downshift. The same applies to other upshifts and downshifts.

Returning to FIG. 3, the compound transmission 11 further includes a one-way clutch F0. The one-way clutch F0 is a lock mechanism capable of fixing the carrier CA0 so as not to rotate. That is, the one-way clutch F0 is a lock mechanism capable of fixing the connecting shaft 34 that is connected to the crankshaft of the engine 2 and rotates integrally with the carrier CA0 to the transmission case 110. In the one-way clutch F0, one of two members capable of rotating with respect to each other is integrally connected to the connecting shaft 34, and the other member is integrally connected to the transmission case 110. The one-way clutch F0 idles in the forward rotation direction that is the rotation direction of the engine 2 during operation, and automatically engages with the rotation direction opposite to that during operation of the engine 2. Therefore, when the one-way clutch F0 idles, the engine 2 is in a state of being able to rotate relative to the transmission case 110. On the other hand, when the one-way clutch F0 is engaged, the engine 2 is in a state of being not able to rotate relative to the transmission case 110. That is, the engine 2 is fixed to the transmission case 110 as the one-way clutch F0 is engaged. As described above, the one-way clutch F0 allows the carrier CA0 to rotate in the forward rotation direction that is the rotation direction during operation of the engine 2, and blocks the carrier CA0 from rotating in the negative rotation direction. That is, the one-way clutch F0 is a lock mechanism capable of allowing the engine 2 to rotate in the forward rotation direction and blocks the engine 2 from rotating in the negative rotation direction.

In the compound transmission 11, a continuously variable transmission in which the continuously variable transmission unit 20 and the stepped transmission unit 22 are disposed in series can be configured by the stepped transmission unit 22 in which the AT gear stages are formed and the continuously variable transmission unit 20 that is operated as the continuously variable transmission. Alternatively, the continuously variable transmission unit 20 can be caused to execute shifting in a similar manner to that of the stepped transmission. Therefore, the compound transmission 11 as a whole can be caused to execute shifting in a similar manner as that of the stepped transmission. That is, in the compound transmission 11, the stepped transmission unit 22 and the continuously variable transmission unit 20 can be controlled such that the gear stages having different gear ratios, each of which represents the value of the ratio of the engine speed to the output rotational speed, are selectively established.

The electronic control device 100 executes shift determination of the stepped transmission unit 22 using an AT gear stage shift map as shown in FIG. 5 that is a predetermined relationship, for example, and executes the shift control of the stepped transmission unit 22 via the transmission control device 103 as needed. In the shift control of the stepped transmission unit 22, the transmission control device 103 outputs, to the hydraulic control circuit 111, a hydraulic control command signal for switching the engagement-disengagement state of the engaging device by each solenoid valve so as to automatically switch the AT gear stage of the stepped transmission unit 22.

The AT gear stage shift map shown in FIG. 5 has, for example, a predetermined relationship having a shift line for determining the shifting of the stepped transmission unit 22 on the two-dimensional coordinates with the required drive torque calculated based on the vehicle speed and the accelerator operation amount as variables. In the AT gear stage shift map, the output rotational speed or the like may be used instead of the vehicle speed, or the required driving force, the accelerator operation amount, the throttle valve opening, or the like may be used instead of the required drive torque. In the AT gear stage shift map shown in FIG. 5, the shift lines shown by the solid lines are each upshift line for determining the upshift, and the shift lines shown by the broken lines are each shift line for determining the downshift.

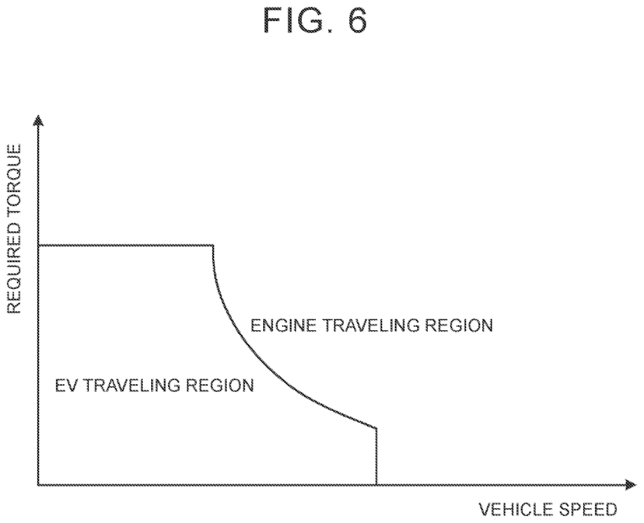

FIG. 6 is a diagram showing an example of a power source switching map used in switching control between the EV traveling mode and the engine traveling mode. In the vehicle 1 according to the first embodiment, the EV traveling mode and the engine traveling mode are switched based on the power source switching map used in the switching control between the EV traveling mode and the engine traveling mode as shown in FIG. 6. The map shown in FIG. 6 has a predetermined relationship having a boundary between an engine traveling region in which that the vehicle travels in the engine traveling mode and an EV traveling region in which the vehicle travels in the EV traveling mode on the two-dimensional coordinates with the vehicle speed and the required drive torque as variables. The boundary between the EV traveling region and the engine traveling region in FIG. 6 is, in other words, a switching line for switching between the EV traveling mode and the engine traveling mode.

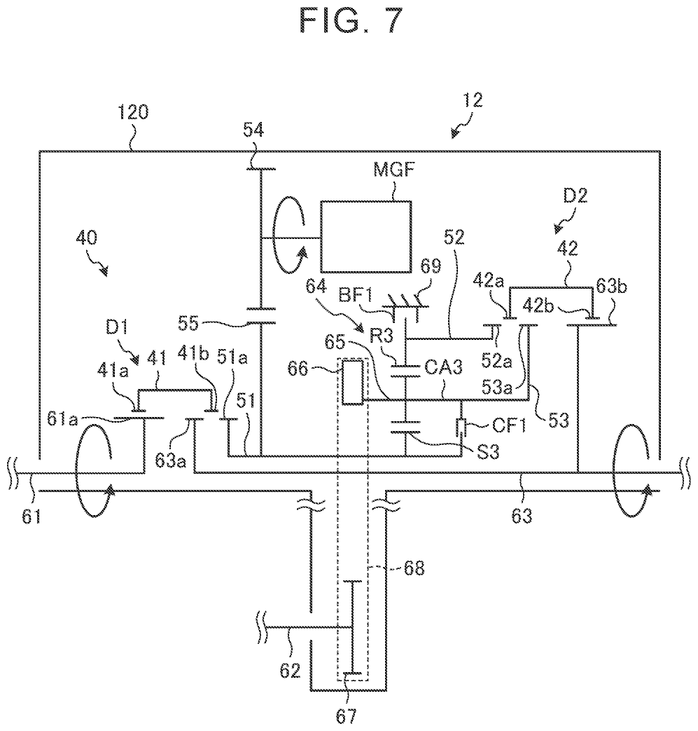

FIG. 7 is a skeleton diagram schematically showing the transfer 12 according to the first embodiment, and is a skeleton diagram showing a case where the transfer 12 is in a first driving state.

The transfer 12 according to the first embodiment includes a transfer case 120 that is a non-rotating member. The transfer 12 includes, in the transfer case 120, an input shaft 61, a rear wheel side output shaft 63 as a first output shaft outputting power to the rear wheels 4, a front wheel side output shaft 62 as a second output shaft outputting power to the front wheels 3, and a third planetary gear device 64 as a differential mechanism. Further, the transfer 12 includes, in the transfer case 120, a transfer member 65 that functions as an input member to the front wheels 3 as a rotating member constituting a power transfer path for the front wheels 3, a drive gear 66 that outputs power to the front wheel side output shaft 62, a driven gear 67 integrally provided with the front wheel side output shaft 62, and a front wheel drive chain 68 that connects the drive gear 66 and the driven gear 67. Further, the transfer 12 includes, in the transfer case 120, the third rotating electric machine MGF that functions as a second power source, a connection switching device 40 that switches the connection state of the rotating members, a clutch CF1, and a brake BF1.

The input shaft 61 is an input rotating member that inputs power from the engine 2 (and the first rotating electric machine MG1 and the second rotating electric machine MG2) to the transfer 12. The power from the engine 2 is transferred to the input shaft 61 via the compound transmission 11. For example, the input shaft 61 is spline-fitted to the output shaft 24 that is an output rotating member of the compound transmission 11.

The rear wheel side output shaft 63 is an output rotating member that outputs power from the transfer 12 to the rear wheels 4. The rear wheel side output shaft 63 is a main drive shaft disposed coaxially with the input shaft 61 and connected to the rear propeller shaft 14 (see FIG. 1).

The front wheel side output shaft 62 is an output rotating member that outputs power from the transfer 12 to the front wheels 3. The front wheel side output shaft 62 is a drive shaft disposed on a different axis from the input shaft 61 and the rear wheel side output shaft 63 and connected to the front propeller shaft 13 (see FIG. 1). The front wheel side output shaft 62 rotates via the front wheel drive chain 68 and the driven gear 67 as the drive gear 66 rotates.

The drive gear 66 is connected to the transfer member 65 so as to rotate integrally. The transfer member 65 is a rotating member that transfers power to the front wheel side output shaft 62. The transfer member 65 and the drive gear 66 are disposed so as to be rotatable relative to the rear wheel side output shaft 63. In the transfer 12, the transfer member 65, the drive gear 66, and the third planetary gear device 64 are disposed on the same rotation center as the rear wheel side output shaft 63.

The third planetary gear device 64 is configured by a single pinion type planetary gear device including three rotating elements. As shown in FIG. 7, the third planetary gear device 64 includes, as the three rotating elements, a sun gear S3, a carrier CA3 that supports a plurality of pairs of pinion gears that mesh with each other so as to be rotatable and revolvable, and a ring gear R3 that meshes with the sun gear S3 via the pinion gears. The third rotating electric machine MGF that functions as the second power source is constantly connected to the sun gear S3.

A first rotating member 51 that can be connected to the input shaft 61 is connected to the sun gear S3. The first rotating member 51 is a member that rotates integrally with the sun gear S3 and includes gear teeth 51a. Further, the first rotating member 51 is attached with an input gear 55 to which power from the third rotating electric machine MGF is input. The input gear 55 and the first rotating member 51 rotate integrally.

A third rotating member 53 that can be connected to the rear wheel side output shaft 63 is connected to the carrier CA3. The third rotating member 53 is a member that rotates integrally with the carrier CA3 and includes gear teeth 53a. Further, the transfer member 65 is connected to the carrier CA3. The transfer member 65 is a member that rotates integrally with the carrier CA3.

The second rotating member 52 that can be connected to the rear wheel side output shaft 63 is connected to the ring gear R3. The second rotating member 52 is a member that rotates integrally with the ring gear R3 and includes gear teeth 52a.

The third rotating electric machine MGF is a motor generator (MG) capable of functioning as a motor and a generator. The third rotating electric machine MGF includes a rotor, a stator, and an output shaft that rotates integrally with the rotor, and is electrically connected to the battery via an inverter. As shown in FIG. 7, an output gear 54 is provided on the output shaft of the third rotating electric machine MGF. The output gear 54 meshes with the input gear 55, and the output gear 54 and the input gear 55 constitute a reduction gear train. Therefore, when MGF torque that is the output torque from the third rotating electric machine MGF is transferred to the input gear 55, rotation of the third rotating electric machine MGF is subjected to speed change (decelerated) and transferred to the sun gear S3.

The connection switching device 40 is a device that selectively switches the connection destinations of the input shaft 61 and the rear wheel side output shaft 63. Further, the connection switching device 40 is a device for switching the connection state of the rotating members constituting the transfer 12. Specifically, the connection switching device 40 selectively switches the connection destinations of the first rotating member 51, the second rotating member 52, and the third rotating member 53 that rotate integrally with each rotating element of the third planetary gear device 64. As shown in FIG. 7, the connection switching device 40 includes a first dog clutch D1 and a second dog clutch D2.

The first dog clutch D1 is a first disconnection-connection mechanism for switching the connection destination of the input shaft 61. As shown in FIG. 7, the first dog clutch D1 selectively connects the input shaft 61 and the first rotating member 51 (sun gear S3) or the rear wheel side output shaft 63. That is, the first dog clutch D1 switches between a first input state and a second input state. In the first input state, the power from the input shaft 61 is transferred to the rear wheel side output shaft 63 without intervening the third planetary gear device 64. In the second input state, the power from the input shaft 61 is transferred to the rear wheel side output shaft 63 via the third planetary gear device 64.

The first dog clutch D1 includes a first switching sleeve 41 as an input switching member. The first switching sleeve 41 includes first gear teeth 41a that mesh with gear teeth 61a of the input shaft 61 and second gear teeth 41b that mesh with first gear teeth 63a of the rear wheel side output shaft 63 or the gear teeth 51a of the first rotating member 51. The first switching sleeve 41 is moved in the axial direction by the actuator of the first dog clutch D1. The first switching sleeve 41 is switched to any of a state in which the second gear teeth 41b mesh with the first gear teeth 63a of the rear wheel side output shaft 63 while the first gear teeth 41a constantly mesh with the gear teeth 61a of the input shaft 61, a state in which the second gear teeth 41b do not mesh with any of the first gear teeth 63a of the rear wheel side output shaft 63 and the gear teeth 51a of the first rotating member 51, and a state in which the second gear teeth 41b mesh with the gear teeth 51a of the first rotating member 51. When the second gear teeth 41b of the first switching sleeve 41 mesh with the gear teeth 51a of the first rotating member 51, the input state is switched to the second input state in which the power from the input shaft 61 is input to the first rotating member 51 (sun gear S3). On the other hand, when the second gear teeth 41b of the first switching sleeve 41 mesh with the first gear teeth 63a of the rear wheel side output shaft 63, the input state is switched to the first input state in which the power from the input shaft 61 is input to the rear wheel side output shaft 63.

The second dog clutch D2 is a second disconnection-connection mechanism for switching the connection destination of the rear wheel side output shaft 63. The second dog clutch D2 selectively connects the rear wheel side output shaft 63 and the second rotating member 52 (ring gear R3) or the third rotating member 53 (carrier CA3).

The second dog clutch D2 includes a second switching sleeve 42 as a switching member. The second switching sleeve 42 includes first gear teeth 42a and second gear teeth 42b. The first gear teeth 42a of the second switching sleeve 42 can selectively mesh with the gear teeth 52a of the second rotating member 52 that rotates integrally with the ring gear R3 and the gear teeth 53a of the third rotating member 53 that rotates integrally with the carrier CA3. The second switching sleeve 42 is moved in the axial direction by the actuator of the second dog clutch D2. Then, the second switching sleeve 42 is switched to any of a state in which the first gear teeth 42a mesh with the gear teeth 52a of the second rotating member 52 while the second gear teeth 42b constantly mesh with the second gear teeth 63b of the rear wheel side output shaft 63, a state in which the first gear teeth 42a do not mesh with any of the gear teeth 52a of the second rotating member 52 and the gear teeth 53a of the third rotating member 53, and a state in which the first gear teeth 42a mesh with the gear teeth 53a of the third rotating member 53. When the first gear teeth 42a of the second switching sleeve 42 mesh with the gear teeth 52a of the second rotating member 52, the state is switched to a first transfer state in which the power is transferred between the rear wheel side output shaft 63 and the second rotating member 52 (ring gear R3). On the other hand, when the first gear teeth 42a of the second switching sleeve 42 mesh with the gear teeth 53a of the third rotating member 53, the state is switched to a second transfer state in which the power is transferred between the rear wheel side output shaft 63 and the third rotating member 53 (carrier CA3).

The clutch CF1 is an engaging element of a differential mechanism that selectively engages the sun gear S3 and the carrier CA3 of the third planetary gear device 64 and integrally rotates the sun gear S3, the carrier CA3, and the ring gear R3. The brake BF1 is a fixing element of a differential mechanism that selectively fixes the ring gear R3 of the third planetary gear device 64 to a fixing member 69. The fixing member 69 is the transfer case 120 itself or a non-rotating member integrated with the transfer case 120.

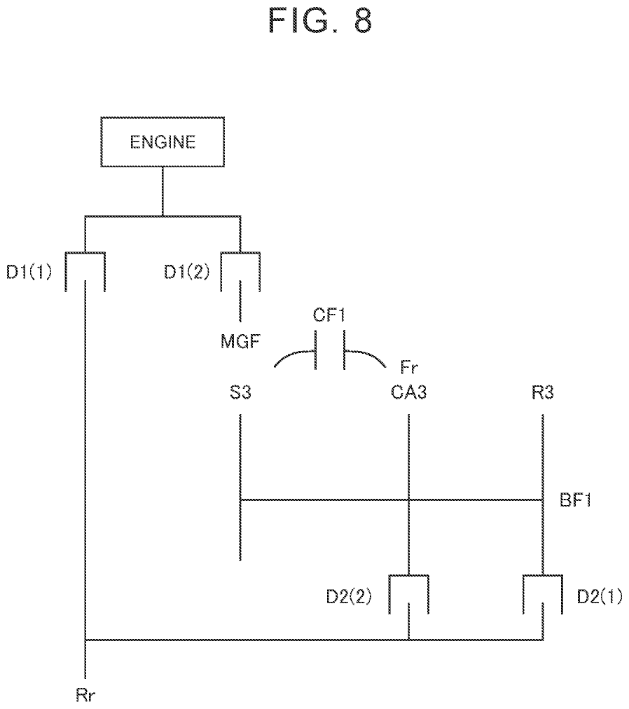

FIG. 8 is a diagram showing the engagement relationship of each rotating member in the transfer 12 according to the first embodiment. In FIG. 8, the third rotating electric machine MGF is referred to as “MGF”, the sun gear S3 is “S3”, the carrier CA3 is “CA3”, the ring gear R3 is “R3”, the brake BF1 is “BF1”, the clutch CF1 is “CH”, the front wheel side output shaft 62 is “Fr”, and the rear wheel side output shaft 63 is “Rr”. Further, in FIG. 8, D1 (1) indicates the connection location of the first dog clutch D1 in the first input state, and D1 (2) indicates the connection location of the first dog clutch D1 in the second input state. Further, in FIG. 8, D2 (1) shows the connection point of the second dog clutch D2 in the first transfer state, and D2 (2) shows the connection point of the second dog clutch D2 in the second transfer state.

The transfer 12 according to the first embodiment includes the rear wheel side output shaft 63 that is connected to the engine 2 (and the first rotating electric machine MG1 and the second rotating electric machine MG2) as a power source and outputs power to the rear wheels 4 that are one of the front wheels 3 and the rear wheels 4, the front wheel side output shaft 62 that is the second output shaft outputting the power to the front wheels 3 that are the other of the front wheels 3 and the rear wheels 4, the third planetary gear device 64 that is a differential mechanism including the ring gear R3 that is the first rotating element connected to the rear wheel side output shaft 63, the carrier CA3 that is the second rotating element connected to the front wheel side output shaft 62, the sun gear S3 being the third rotating element connected to the third rotating electric machine MGF, and a clutch CF1 that is an engaging element that selectively engages the carrier CA3 and the sun gear S3 being any two of the first rotating element, the second rotating element, and the third rotating element. With this configuration, in the transfer 12 according to the first embodiment, the torque distribution ratio at which torque is distributed to the front wheel side output shaft 62 and the rear wheel side output shaft 63 can be changed by controlling the MGF torque from the third rotating electric machine MGF.

The drive state of the transfer 12 according to the first embodiment is switched by the electronic control device 100 such that a first drive state, a second drive state, a third drive state, a fourth drive state, a fifth drive state, and a sixth drive state can be set.

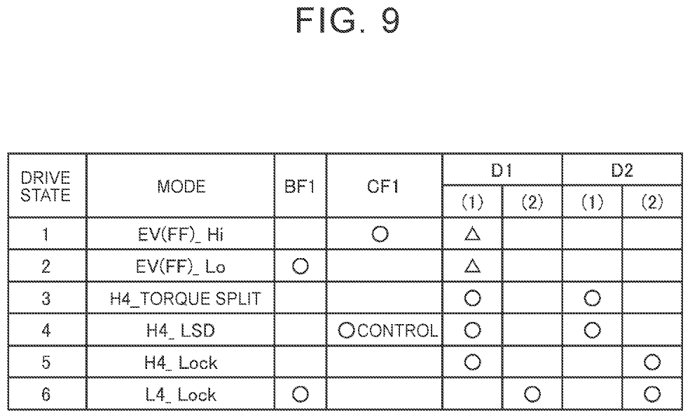

Here, the first drive state to the sixth drive state will be described. FIG. 9 is a diagram showing the relationship between each of the drive states of the transfer 12 and an operating state of each engaging device. In FIG. 9, a white circle indicates engagement, a while triangle indicates engagement as needed, and blank indicates disengagement.

The first drive state shown in FIG. 7 is a drive state in the EV traveling mode in which the vehicle 1 travels using the power from the third rotating electric machine MGF in the EV(FF)_Hi mode, and also in a two-wheel drive state in which the power from the third rotating electric machine MGF is transferred only to the front wheels 3. Rotation of the third rotating electric machine MGF is transferred to the front wheel side output shaft 62 without speed reduction by the third planetary gear device 64. In the first drive state, the transfer 12 is set to a high-speed side shift stage Hi.

When the transfer 12 is in the first drive state, as shown in FIG. 9, the brake BF1 is disengaged, the clutch CF1 is engaged, the first dog clutch D1 is disengaged, and the second dog clutch D2 is disengaged. In the first drive state, the third planetary gear device 64 is in a direct connection state in which the sun gear S3 and the carrier CA3 are connected by the clutch CF1. In the first drive state, the third rotating electric machine MGF is connected to the front wheel side output shaft 62 on the power transfer path via the third planetary gear device 64 in the non-shifting state. Therefore, in the first drive state, when the power from the third rotating electric machine MGF is transferred to the front wheel side output shaft 62, the rotation of the third rotating electric machine MGF is transferred to the front wheel side output shaft 62 without speed change by the third planetary gear device 64.

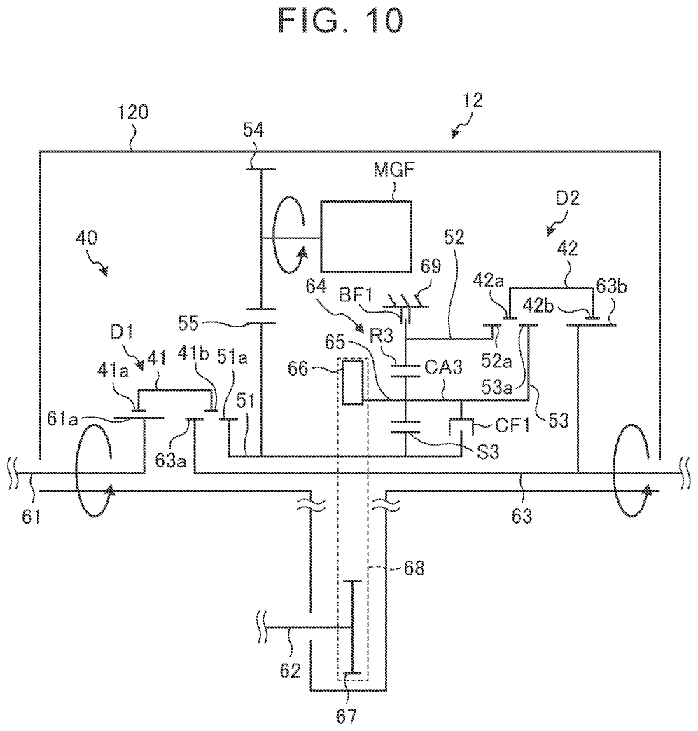

FIG. 10 is a skeleton diagram showing a case where the transfer 12 according to the first embodiment is in the second drive state. The second drive state is a drive state in the EV traveling mode in which the vehicle 1 travels using the power from the third rotating electric machine MGF in the EV(FF)_Lo mode, and also in the two-wheel drive state in which the power from the third rotating electric machine MGF is transferred only to the front wheels 3. Rotation of the third rotating electric machine MGF is transferred to the front wheel side output shaft 62 after speed reduction by the third planetary gear device 64. In the second drive state, the transfer 12 is set to a low-speed side shift stage Lo.

When the transfer 12 is in the second drive state, as shown in FIG. 9, the brake BF1 is engaged, the clutch CF1 is disengaged, the first dog clutch D1 is disengaged, and the second dog clutch D2 is disengaged. In the second drive state, the third planetary gear device 64 is in a speed reduction state in which the ring gear R3 is mechanically fixed to the fixing member 69 by the brake BF1. Further, in the second drive state, the third rotating electric machine MGF is connected to the front wheel side output shaft 62 on the power transfer path via the third planetary gear device 64 in the shifting state. Therefore, in the second drive state, when the power from the third rotating electric machine MGF is transferred to the front wheel side output shaft 62, the rotation of the third rotating electric machine MGF is transferred to the front wheel side output shaft 62 after speed change by the third planetary gear device 64.

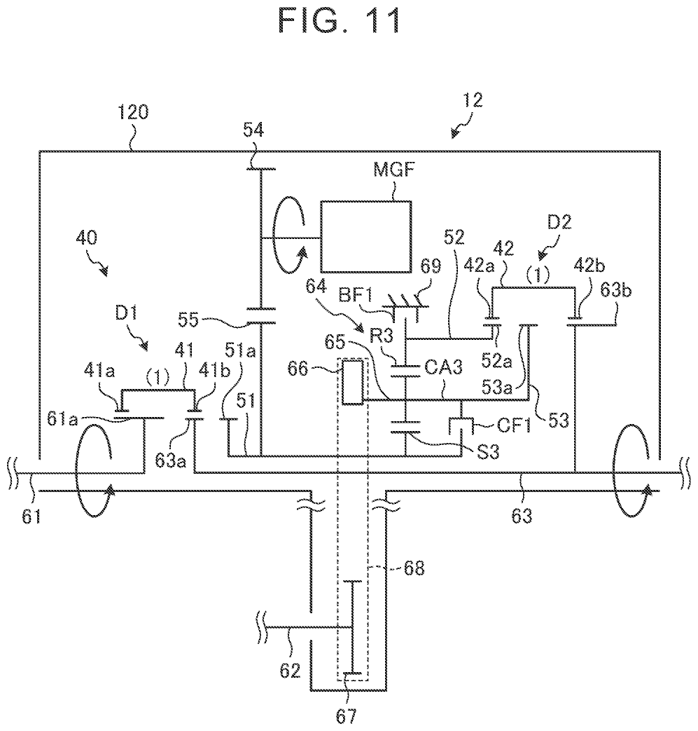

FIG. 11 is a skeleton diagram showing a case where the transfer 12 according to the first embodiment is in the third drive state. The third drive state is a drive state in a mode in which the power transferred to the transfer 12 in the H4_torque split mode is distributed to the front wheel 3 side and the rear wheel 4 side to cause the vehicle 1 to travel, and is also a four-wheel drive state in which the power is distributed to the front wheels 3 and the rear wheels 4. The torque distribution ratio at which the torque from the input shaft 61 is distributed to the front wheel side output shaft 62 and the rear wheel side output shaft 63 can be changed using the MGF torque from the third rotating electric machine MGF. In other words, the sun gear S3 of the third planetary gear device 64 receives the torque transferred from the rear wheel side output shaft 63 to the ring gear R3 of the third planetary gear device 64 with the MGF torque from the third rotating electric machine MGF as a reaction force such that the torque from the input shaft 61 can be distributed to the front wheel 3 side and the rear wheel 4 side at an arbitrary ratio. In the third drive state, the transfer 12 is set to the high-speed side shift stage Hi.

When the transfer 12 is in the third drive state, as shown in FIG. 9, the brake BF1 is disengaged, the clutch CF1 is disengaged, the first dog clutch D1 is in the first input state, and the second dog clutch D2 is in the first transfer state. Note that, (1) in the first dog clutch D1 in FIG. 11 indicates that the first dog clutch D1 is in the first input state. Further, (1) in the second dog clutch D2 in FIG. 11 indicates that the second dog clutch D2 is in the first transfer state. In the first switching sleeve 41 in the first input state, the first gear teeth 41a mesh with the gear teeth 61a of the input shaft 61, and the second gear teeth 41b mesh with the first gear teeth 63a of the rear wheel side output shaft 63. Further, in the second switching sleeve 42 in the first transfer state, the first gear teeth 42a mesh with the gear teeth 52a of the second rotating member 52, and the second gear teeth 42b mesh with the second gear teeth 63b of the rear wheel side output shaft 63. As described above, in the third drive state, the input shaft 61 is connected to the rear wheel side output shaft 63 by the first dog clutch D1, and the rear wheel side output shaft 63 is connected to the second rotating member 52 by the second dog clutch D2. In the third drive state, the rotational differential between the front propeller shaft 13 and the rear propeller shaft 14 is not limited.

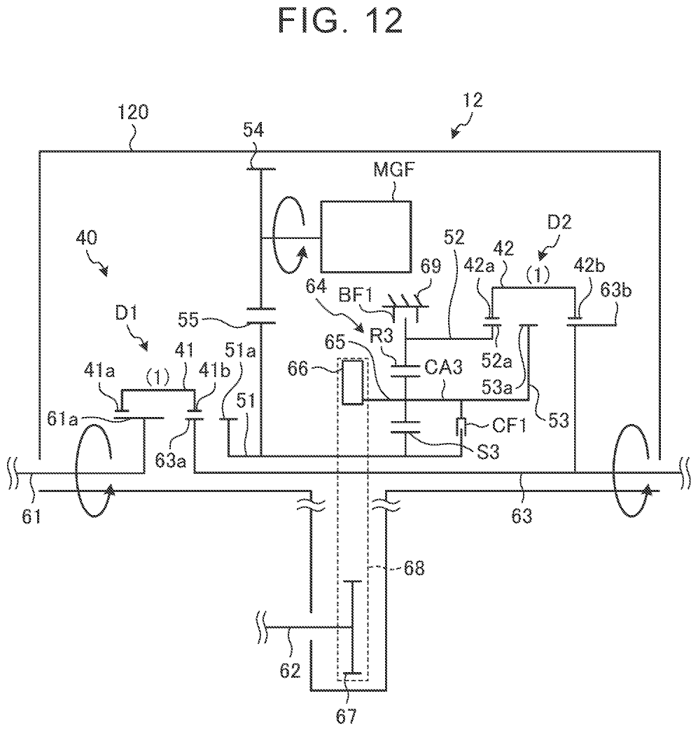

FIG. 12 is a skeleton diagram showing a case where the transfer 12 according to the first embodiment is in the fourth drive state. The fourth drive state is a drive state in a mode in which the power transferred to the transfer 12 in the H4_LSD mode is distributed to the front wheel 3 side and the rear wheel 4 side to cause the vehicle 1 to travel, and is also in the four-wheel drive state in which the power is transferred to the front wheels 3 and the rear wheels 4. The power transferred from the rear wheel side output shaft 63 to the ring gear R3 of the third planetary gear device 64 is distributed to the front wheel 3 side and the rear wheel 4 side while the clutch CF1 is slipped. In the fourth drive state, the transfer 12 is set to the high-speed side shift stage Hi.

When the transfer 12 is in the fourth drive state, as shown in FIG. 9, the brake BF1 is disengaged, the clutch CF1 is under engagement control (half engaged), the first dog clutch D1 is in the first input state, and the second dog clutch D2 is in the first transfer state. Note that, (1) in the first dog clutch D1 in FIG. 12 indicates that the first dog clutch D1 is in the first input state. Further, (1) in the second dog clutch D2 in FIG. 12 indicates that the second dog clutch D2 is in the first transfer state. In the first switching sleeve 41 in the first input state, the first gear teeth 41a mesh with the gear teeth 61a of the input shaft 61, and the second gear teeth 41b mesh with the first gear teeth 63a of the rear wheel side output shaft 63. Further, in the second switching sleeve 42 in the first transfer state, the first gear teeth 42a mesh with the gear teeth 52a of the second rotating member 52, and the second gear teeth 42b mesh with the second gear teeth 63b of the rear wheel side output shaft 63. As described above, in the fourth drive state, the input shaft 61 is connected to the rear wheel side output shaft 63 by the first dog clutch D1, and the rear wheel side output shaft 63 is connected to the second rotating member 52 by the second dog clutch D2. In the fourth drive state, the rotational differential between the front propeller shaft 13 and the rear propeller shaft 14 is restricted.

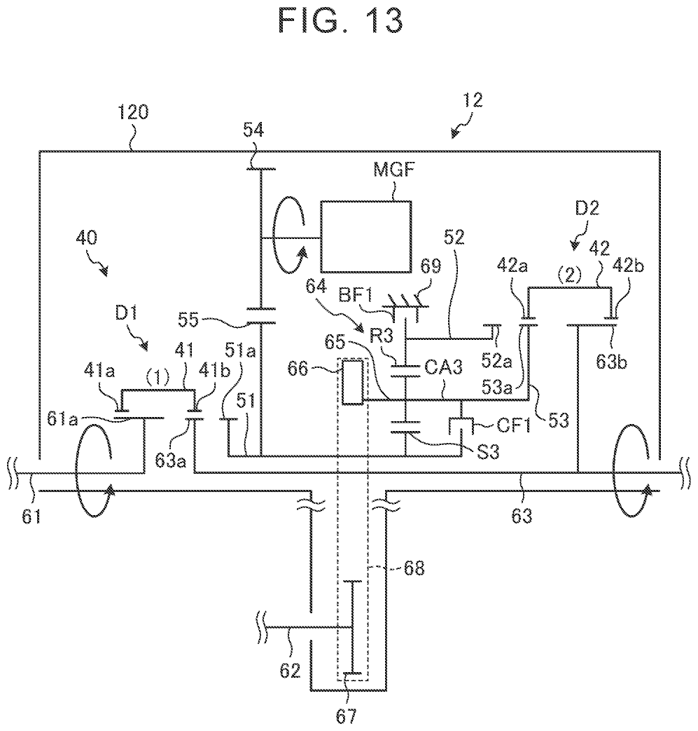

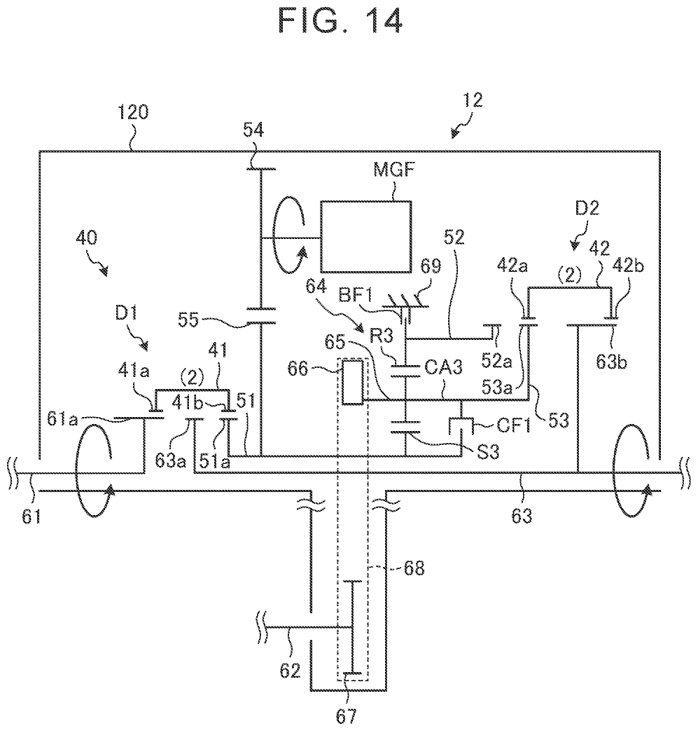

FIG. 13 is a skeleton diagram showing a case where the transfer 12 according to the first embodiment is in the fifth drive state. The fifth drive state is a drive state in a mode in which the power transferred to the transfer 12 in the H4_Lock mode (fixed distribution 4WD) is distributed to the front wheel 3 side and the rear wheel 4 side to cause the vehicle 1 to travel, and is also in a four-wheel drive state in which the power is transferred to the front wheels 3 and the rear wheels 4. The distribution ratio of the power transferred to the front wheels 3 and the rear wheels 4 is fixed. Note that, in the fifth drive state, the transfer 12 is set to the high-speed side shift stage Hi.

When the transfer 12 is in the fifth drive state, as shown in FIG. 9, the brake BF1 is disengaged, the clutch CF1 is disengaged, the first dog clutch D1 is in the first input state, and the second dog clutch D2 is in the second transfer state. Note that, (1) in the first dog clutch D1 in FIG. 13 indicates that the first dog clutch D1 is in the first input state. Further, (2) in the second dog clutch D2 in FIG. 13 indicates that the second dog clutch D2 is in the second transfer state. In the first switching sleeve 41 in the first input state, the first gear teeth 41a mesh with the gear teeth 61a of the input shaft 61, and the second gear teeth 41b mesh with the first gear teeth 63a of the rear wheel side output shaft 63. In the second switching sleeve 42 in the second transfer state, the first gear teeth 42a mesh with the gear teeth 53a of the third rotating member 53, and the second gear teeth 42b mesh with the second gear teeth 63b of the rear wheel side output shaft 63. As described above, in the fifth drive state, the input shaft 61 is connected to the rear wheel side output shaft 63 by the first dog clutch D1, and the rear wheel side output shaft 63 is connected to the third rotating member 53 by the second dog clutch D2. Further, in the fifth drive state, the rotational differential between the front propeller shaft 13 and the rear propeller shaft 14 is disabled.

FIG. 14 is a skeleton diagram showing a case where the transfer 12 according to the first embodiment is in the sixth drive state. The sixth drive state is a drive state in a mode in which the power transferred to the transfer 12 in the L4_Lock mode (fixed distribution 4WD) is distributed to the front wheel 3 side and the rear wheel 4 side to cause the vehicle 1 to travel, and is also in the four-wheel drive state in which the power is transferred to the front wheels 3 and the rear wheels 4. The distribution ratio of the power transferred to the front wheels 3 and the rear wheels 4 is fixed. In the sixth drive state, the transfer 12 is set to the low-speed side shift stage Lo.

When the transfer 12 is in the sixth drive state, as shown in FIG. 9, the brake BF1 is engaged, the clutch CF1 is disengaged, the first dog clutch D1 is in the second input state, and the second dog clutch D2 is in the second transfer state. Note that, (2) in the first dog clutch D1 in FIG. 14 indicates that the first dog clutch D1 is in the second input state. Further, (2) in the second dog clutch D2 in FIG. 14 indicates that the second dog clutch D2 is in the second transfer state. In the first switching sleeve 41 in the second input state, the first gear teeth 41a mesh with the gear teeth 61a of the input shaft 61, and the second gear teeth 41b mesh with the gear teeth 51a of the first rotating member 51. In the second switching sleeve 42 in the second transfer state, the first gear teeth 42a mesh with the gear teeth 53a of the third rotating member 53, and the second gear teeth 42b mesh with the second gear teeth 63b of the rear wheel side output shaft 63. As described above, in the sixth drive state, the input shaft 61 is connected to the first rotating member 51 by the first dog clutch D1, and the rear wheel side output shaft 63 is connected to the third rotating member 53 by the second dog clutch D2. Further, in the sixth drive state, the rotational differential between the front propeller shaft 13 and the rear propeller shaft 14 is disabled.

In the transfer 12 according to the first embodiment, the drive states can be switched between the first drive state and the second drive state, and the third drive state and the fourth drive state in accordance with the traveling state of the vehicle 1. Further, in the fifth drive state, the drive states can be switched between the fifth state and the third drive state and the fourth drive state as the driver turns on and off the Lock selection switch 92 provided on the vehicle 1. Further, in the sixth drive state, the drive states can be switched between the fifth drive state and the sixth drive state as the driver turns on and off the Low selection switch 90 provided on the vehicle 1 when the vehicle is stopped.

In order to switch the drive state of the transfer 12, the electronic control device 100 controls the hydraulic control circuit 111 by the transfer control device 104 based on output signals from various sensors mounted on the vehicle 1, the 4WD selection switch 86, the Low selection switch 90, and the like, and controls the operating states of the actuator that operates the first dog clutch D1 and the second dog clutch D2, the clutch CF1, and the brake BF1.

Further, the electronic control device 100 can set, as the traveling mode of the vehicle 1, a first traveling mode in which the vehicle 1 travels using power from at least the engine 2 (and the first rotating electric machine MG1 and the second rotating electric machine MG2) as the first power source and the EV traveling mode that is a second traveling mode in which the vehicle 1 travels using power from the third rotating electric machine MGF as the second power source.

When the H4_torque split mode is set as the first traveling mode, the electronic control device 100 controls the MGF torque from the third rotating electric machine MGF so as to change the torque distribution ratio at which the torque from the input shaft 61 is distributed to the front wheel side output shaft 62 and the rear wheel side output shaft 63, that is, to the front wheel 3 side and the rear wheel 4 side. Further, when the MGF torque from the third rotating electric machine MGF is limited and the change of the torque distribution ratio is restricted, the electronic control device 100 changes the torque distribution ratio by controlling the torque capacity of the clutch CF1.

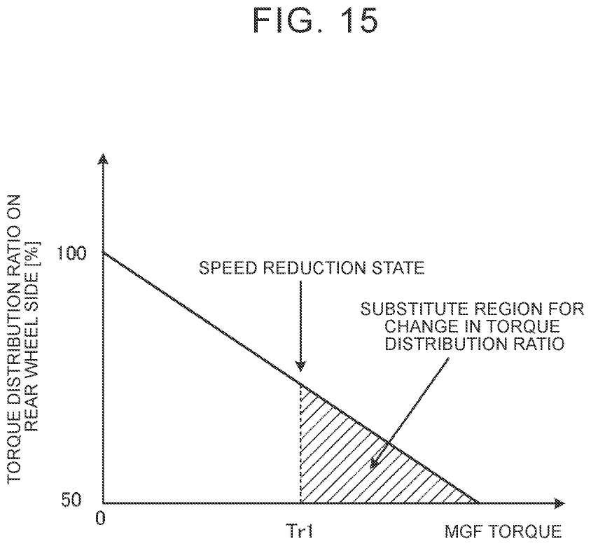

FIG. 15 is a diagram showing the relationship between the MGF torque that is the output torque from the third rotating electric machine MGF, and the torque distribution ratio on the rear wheel 4 side. As shown in FIG. 15, when the MGF torque is 0, the entire torque from the input shaft 61 is transferred to the rear wheel 4 side. As the MGF torque increases, the torque distributed to the front wheel 3 side increases, and the torque distribution ratio on the rear wheel 4 side decreases.

When the H4_torque split mode is set as the first traveling mode, the electronic control device 100 controls, for example, the MGF torque from the third rotating electric machine MGF such that the torque distribution ratio on the rear wheel 4 side becomes the torque distribution ratio that corresponds to the traveling state of the vehicle 1. However, when a load factor limitation is imposed on the third rotating electric machine MGF and the MGF torque is limited in the process of changing the torque distribution ratio on the rear wheel 4 side by controlling the MGF torque from the third rotating electric machine MGF, this limits a change of the torque distribution ratio. Note that, the load factor limitation is imposed on the third rotating electric machine MGF when, for example, the SOC of the battery that supplies electric power to the third rotating electric machine MGF reaches or falls below a predetermined value, or the temperature of the third rotating electric machine MGF reaches or exceeds a predetermined temperature. In this case, the current supplied from the battery to the third rotating electric machine MGF is limited, and the MGF torque is limited. Therefore, when the load factor limitation is imposed on the third rotating electric machine MGF and the torque distribution ratio on the rear wheel 4 side cannot be changed to the required torque distribution ratio, the electronic control device 100 controls the torque capacity of the clutch CF1 and compensates for the change in the torque distribution ratio, instead of controlling the MGF torque from the third rotating electric machine MGF. In FIG. 15, the shaded region indicates a substitute region in which the change of the torque distribution ratio on the rear wheel 4 side is substituted by control of the torque capacity of the clutch CF1 when the MGF torque is limited to Tr1 or less due to the load factor limitation of the third rotating electric machine MGF.

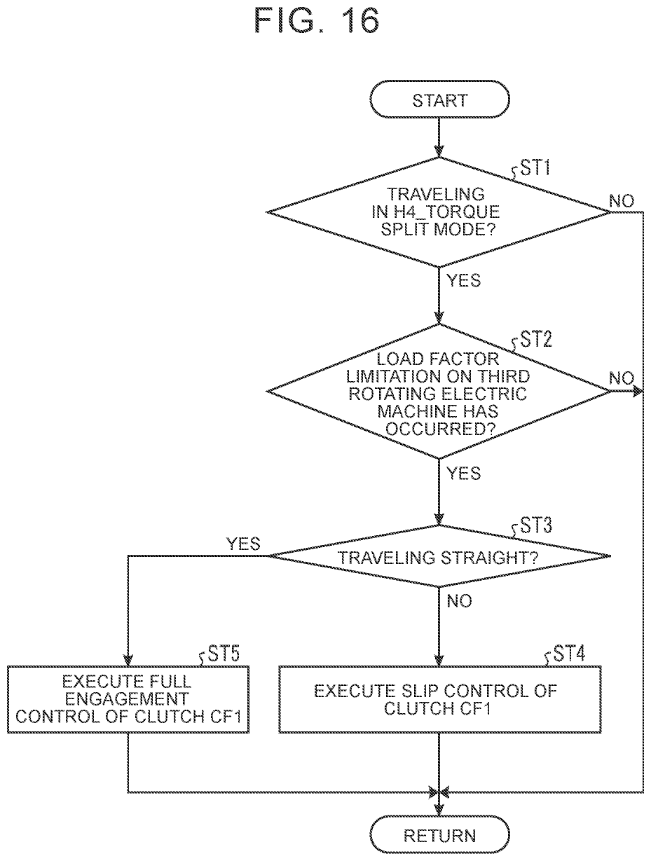

FIG. 16 is a flowchart showing an example of control executed by the electronic control device 100 according to the first embodiment.

First, the electronic control device 100 determines in step ST1 whether the vehicle 1 is traveling in the H4_torque split mode. When the electronic control device 100 determines that the vehicle 1 is not traveling in the H4_torque split mode (No in step ST1), the electronic control device 100 returns a series of controls. On the other hand, when the electronic control device 100 determines that the vehicle 1 is traveling in the H4_split mode (Yes in step ST1), the electronic control device 100 determines in step ST2 whether the load factor limitation is imposed on the third rotating electric machine MGF.

When the electronic control device 100 determines that the load factor limitation is not imposed on the third rotating electric machine MGF (No in step ST2), the torque distribution ratio can be changed only with the MGF torque from the third rotating electric machine MGF. Therefore, the electronic control device 100 returns a series of controls. On the other hand, when the electronic control device 100 determines that the load factor limitation is imposed on the third rotating electric machine MGF (Yes in step ST2), the electronic control device 100 determines in step ST3 whether the vehicle 1 is traveling straight. Here, the electronic control device 100 changes the torque distribution rate such that the torque distribution ratio on the rear wheel 4 side becomes 50% when the vehicle 1 is traveling straight. Further, the electronic control device 100 changes the torque distribution ratio on the rear wheel 4 side such that the yaw rate of the vehicle 1 becomes the target yaw rate when the vehicle 1 is turning.

When the electronic control device 100 determines that the vehicle 1 is turning and not traveling straight (No in step ST3), the electronic control device 100 controls the torque distribution ratio on the rear wheel 4 side in step ST4 such that the yaw rate of the vehicle 1 becomes the target yaw rate. At this time, when the torque distribution ratio on the rear wheel 4 side cannot be changed to the required torque distribution ratio, the electronic control device 100 controls the torque capacity of the clutch CF1, that is, executes slip control of the clutch CF1 such that the yaw rate of the vehicle 1 becomes the target yaw rate so as to change the torque distribution ratio on the rear wheel 4 side. Then, the electronic control device 100 returns a series of controls after executing the process in step ST4.

Further, when the electronic control device 100 determines that the vehicle 1 is traveling straight (Yes in step ST3), the electronic control device 100 executes full engagement control of the clutch CF1 in step ST5 such that the torque distribution ratio on the rear wheel 4 side becomes 50%. Then, the electronic control device 100 returns a series of controls after executing the process in step ST5.

As described above, the electronic control device 100 controls the MGF torque from the third rotating electric machine MGF so as to change the torque distribution ratio at which the torque from the input shaft 61 is distributed to the front wheel side output shaft 62 and the rear wheel side output shaft 63. When the MGF torque from the third rotating electric machine MGF is limited and thus the change of the torque distribution ratio is restricted, the electronic control device 100 changes the torque distribution ratio by controlling the torque capacity of the clutch CF1. Accordingly, with the drive device 10 according to the first embodiment, even when the MGF torque from the third rotating electric machine MGF is limited, and the change of the torque distribution ratio at which the torque is distributed to the front wheel side output shaft 62 and the rear wheel side output shaft 63 is restricted, the torque distribution ratio can be appropriately changed by controlling the torque capacity of the clutch CF1.

### Second Embodiment

Next, the vehicle 1 provided with the drive device 10 according to a second embodiment will be described. In the description of the second embodiment, reference signs are assigned for the same configuration as that of the first embodiment, and the description thereof will be omitted as appropriate.

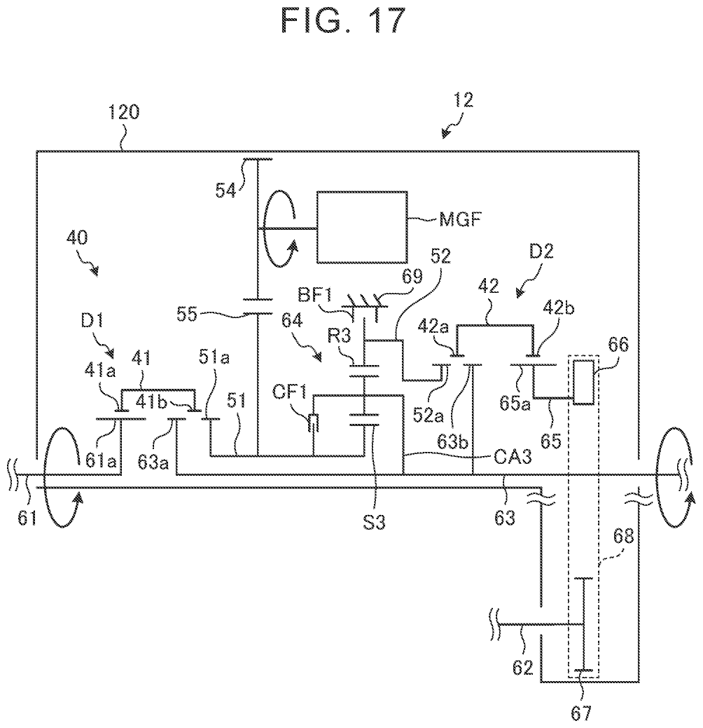

FIG. 17 is a skeleton diagram schematically showing the transfer 12 according to the second embodiment, and is a skeleton diagram showing a case where the transfer 12 is in the first drive state. In the transfer 12 according to the second embodiment, the carrier CA3 of the third planetary gear device 64 is constantly connected to the rear wheel side output shaft 63 so as to rotate integrally with the rear wheel side output shaft 63.

The transfer 12 includes the connection switching device 40 (first dog clutch D1 and second dog clutch D2), the clutch CF1, and the brake BF1.

The transfer 12 according to the second embodiment includes the transfer member 65 that functions as an input member of power to the front wheel 3 side as a rotating member that constitutes a power transfer path on the front wheel 3 side. The transfer member 65 is connected to the drive gear 66 so as to rotate integrally. The transfer member 65 is a rotating member that transfers power to the front wheel side output shaft 62. The transfer member 65 and the drive gear 66 are disposed so as to be rotatable relative to the rear wheel side output shaft 63. In the transfer 12 according to the second embodiment, the transfer member 65, the drive gear 66, and the third planetary gear device 64 are disposed on the same rotation center as the rear wheel side output shaft 63.

The second dog clutch D2 is a second disconnection-connection mechanism for switching the connection destination of the transfer member 65. The second dog clutch D2 can selectively connect the transfer member 65 to the rear wheel side output shaft 63 or the second rotating member 52 (ring gear R3).

The second dog clutch D2 includes a second switching sleeve 42 as a switching member. The second switching sleeve 42 includes the first gear teeth 42a that can mesh with the gear teeth 52a of the second rotating member 52 that rotates integrally with the ring gear R3 or the second gear teeth 63b of the rear wheel side output shaft 63. Further, the second switching sleeve 42 includes the second gear teeth 42b that constantly mesh with the gear teeth 65a of the transfer member 65. The second switching sleeve 42 is moved in the axial direction by the actuator of the second dog clutch D2. The second switching sleeve 42 is switched to any of a state in which the first gear teeth 42a mesh with the gear teeth 52a of the second rotating member 52 while the second gear teeth 42b constantly mesh with the gear teeth 65a of the transfer member 65, a state in which the first gear teeth 42a do not mesh with any of the gear teeth 52a of the second rotating member 52 and the second gear teeth 63b of the rear wheel side output shaft 63, and a state in which the first gear teeth 42a mesh with the second gear teeth 63b of the rear wheel side output shaft 63.

The clutch CF1 is an engaging element of a differential mechanism that selectively connects the sun gear S3 and the carrier CA3 of the third planetary gear device 64 and integrally rotates the sun gear S3, the carrier CA3, and the ring gear R3.

The brake BF1 is a fixing element of a differential mechanism that selectively fixes the ring gear R3 of the third planetary gear device 64 to a fixing member 69. The fixing member 69 is the transfer case 120 itself or a non-rotating member integrated with the transfer case 120.

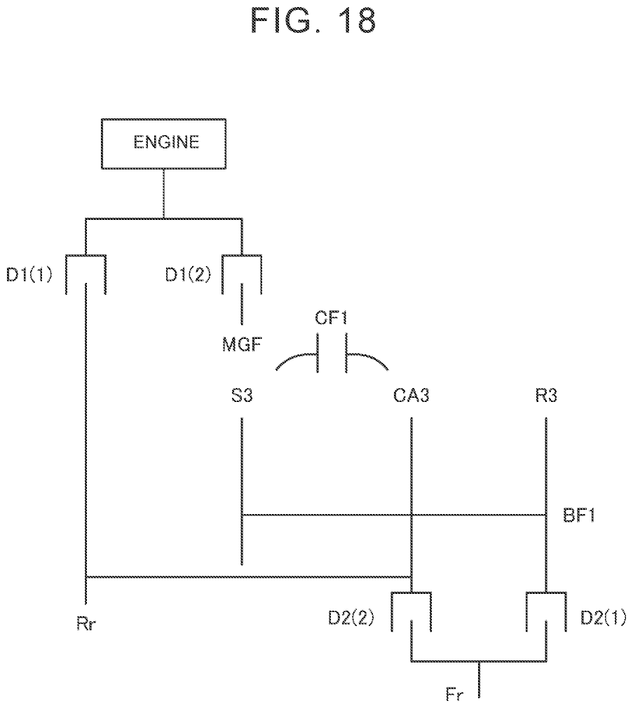

FIG. 18 is a diagram showing the engagement relationship of each rotating member in the transfer 12 according to the second embodiment. The transfer 12 according to the second embodiment includes the rear wheel side output shaft 63 that is connected to the engine 2 (and the first rotating electric machine MG1 and the second rotating electric machine MG2) as a power source and outputs power to the rear wheels 4 that are one of the front wheels 3 and the rear wheels 4, the front wheel side output shaft 62 that is the second output shaft outputting the power to the front wheels 3 that are the other of the front wheels 3 and the rear wheels 4, the carrier CA3 that is the first rotating element connected to the rear wheel side output shaft 63, the ring gear R3 that is the second rotating element connected to the front wheel side output shaft 62, the third planetary gear device 64 that is a differential mechanism including the sun gear S3 being the third rotating element connected to the third rotating electric machine MGF, and the clutch CF1 that is an engaging element that selectively engages the carrier CA3 and the sun gear S3 being any two of the first rotating element, the second rotating element, and the third rotating element.

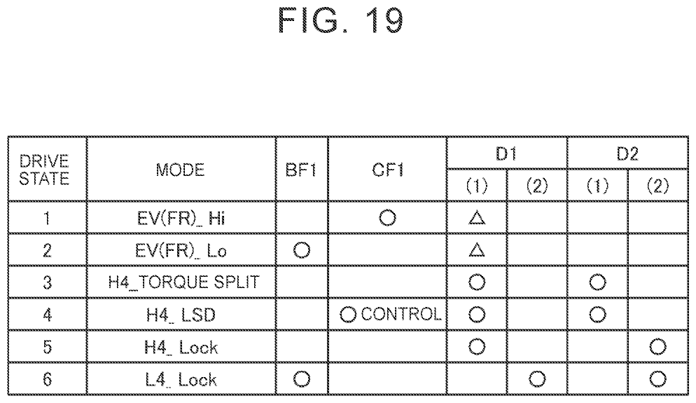

FIG. 19 is a diagram showing the relationship between each of the drive states of the transfer 12 according to the second embodiment and an operating state of each engaging device. In FIG. 19, a white circle indicates engagement, a while triangle indicates engagement as needed, and blank indicates disengagement.

The first drive state shown in FIG. 17 is a drive state in the EV traveling mode in which the vehicle 1 travels using the power from the third rotating electric machine MGF in the EV(FR)_Hi mode, and also in the two-wheel drive state in which the power from the third rotating electric machine MGF is transferred only to the rear wheels 4. Rotation of the third rotating electric machine MGF is transferred to the rear wheel side output shaft 63 without speed reduction by the third planetary gear device 64. Note that, in the first drive state, the transfer 12 is set to the high-speed side shift stage Hi.

When the transfer 12 is in the first drive state, as shown in FIG. 19, the brake BF1 is disengaged, the clutch CF1 is engaged, the first dog clutch D1 is disengaged, and the second dog clutch D2 is disengaged. In the first drive state, the third planetary gear device 64 is in a direct connection state in which the sun gear S3 and the carrier CA3 are connected by the clutch CF1. In the first drive state, the third rotating electric machine MGF is connected to the rear wheel side output shaft 63 on the power transfer path via the third planetary gear device 64 in the non-shifting state. Therefore, in the first drive state, when the power from the third rotating electric machine MGF is transferred to the rear wheel side output shaft 63, the rotation of the third rotating electric machine MGF is transferred to the rear wheel side output shaft 63 without speed change by the third planetary gear device 64.

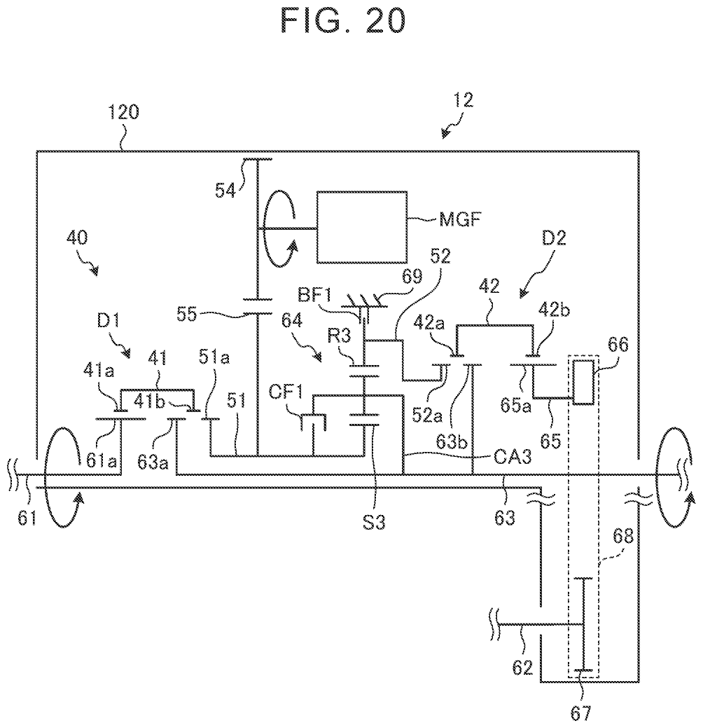

FIG. 20 is a skeleton diagram showing a case where the transfer 12 according to the second embodiment is in the second drive state. The second drive state is a drive state in the EV traveling mode in which the vehicle 1 travels using the power from the third rotating electric machine MGF in the EV(FR)_Lo mode, and also in the two-wheel drive state in which the power from the third rotating electric machine MGF is transferred only to the rear wheels 4. Rotation of the third rotating electric machine MGF is transferred to the rear wheel side output shaft 63 after speed reduction by the third planetary gear device 64. Note that, in the second drive state, the transfer 12 is set to the low-speed side shift stage Lo.

When the transfer 12 is in the second drive state, as shown in FIG. 19, the brake BF1 is engaged, the clutch CF1 is disengaged, the first dog clutch D1 is disengaged, and the second dog clutch D2 is disengaged. In the second drive state, the third planetary gear device 64 is in a speed reduction state in which the ring gear R3 is mechanically fixed to the fixing member 69 by the brake BF1. Further, in the second drive state, the third rotating electric machine MGF is connected to the rear wheel side output shaft 63 on the power transfer path via the third planetary gear device 64 in the shifting state. Therefore, in the second drive state, when the power from the third rotating electric machine MGF is transferred to the rear wheel side output shaft 63, the rotation of the third rotating electric machine MGF is transferred to the rear wheel side output shaft 63 after speed change by the third planetary gear device 64.

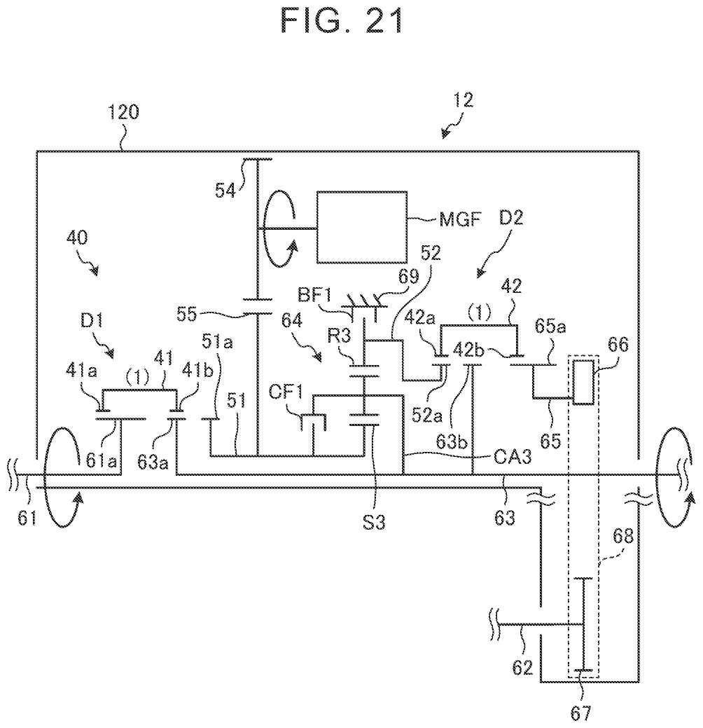

FIG. 21 is a skeleton diagram showing a case where the transfer 12 according to the second embodiment is in the third drive state. The third drive state is a drive state in a mode in which the power transferred to the transfer 12 in the H4_torque split mode is distributed to the front wheel 3 side and the rear wheel 4 side to cause the vehicle 1 to travel, and is also the four-wheel drive state in which the power is distributed to the front wheels 3 and the rear wheels 4. The torque distribution ratio at which the torque from the input shaft 61 is distributed to the front wheel side output shaft 62 and the rear wheel side output shaft 63 can be changed using the MGF torque from the third rotating electric machine MGF. In other words, the sun gear S3 of the third planetary gear device 64 receives the torque transferred from the rear wheel side output shaft 63 to the ring gear R3 of the third planetary gear device 64 with the MGF torque from the third rotating electric machine MGF as a reaction force such that the torque from the input shaft 61 can be distributed to the front wheel 3 side and the rear wheel 4 side at an arbitrary ratio. In the third drive state, the transfer 12 is set to the high-speed side shift stage Hi.

When the transfer 12 is in the third drive state, as shown in FIG. 19, the brake BF1 is disengaged, the clutch CF1 is disengaged, the first dog clutch D1 is in the first input state, and the second dog clutch D2 is in the first transfer state. Note that, (1) in the first dog clutch D1 in FIG. 21 indicates that the first dog clutch D1 is in the first input state. Further, (1) in the second dog clutch D2 in FIG. 21 indicates that the second dog clutch D2 is in the first transfer state. In the first switching sleeve 41 in the first input state, the first gear teeth 41a mesh with the gear teeth 61a of the input shaft 61, and the second gear teeth 41b mesh with the first gear teeth 63a of the rear wheel side output shaft 63. In the second switching sleeve 42 in the first transfer state, the first gear teeth 42a mesh with the gear teeth 52a of the second rotating member 52, and the second gear teeth 42b mesh with the gear teeth 65a of the transfer member 65. In the third drive state, the rotational differential between the front propeller shaft 13 and the rear propeller shaft 14 is not limited.

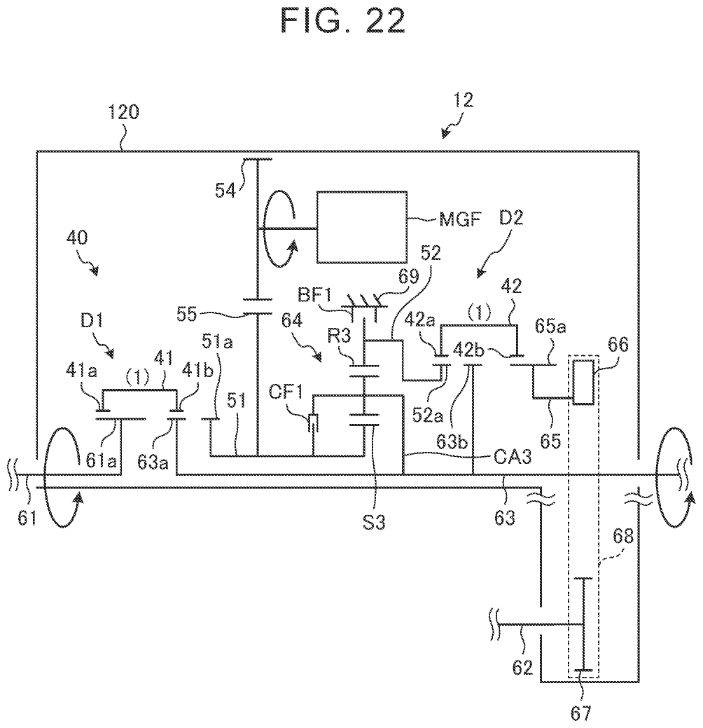

FIG. 22 is a skeleton diagram showing a case where the transfer 12 according to the second embodiment is in the fourth drive state. The fourth drive state is a drive state in a mode in which the power transferred to the transfer 12 in the H4_LSD mode is distributed to the front wheel 3 side and the rear wheel 4 side to cause the vehicle 1 to travel, and is also in the four-wheel drive state in which the power is transferred to the front wheels 3 and the rear wheels 4. The power transferred from the rear wheel side output shaft 63 to the ring gear R3 of the third planetary gear device 64 is distributed to the front wheel 3 side and the rear wheel 4 side while the clutch CF1 is slipped. In the fourth drive state, the transfer 12 is set to the high-speed side shift stage Hi.

When the transfer 12 is in the fourth drive state, as shown in FIG. 19, the brake BF1 is disengaged, the clutch CF1 is under engagement control (half engaged), the first dog clutch D1 is in the first input state, and the second dog clutch D2 is in the first transfer state. Note that, (1) in the first dog clutch D1 in FIG. 22 indicates that the first dog clutch D1 is in the first input state. Further, (1) in the second dog clutch D2 in FIG. 22 indicates that the second dog clutch D2 is in the first transfer state. In the first switching sleeve 41 in the first input state, the first gear teeth 41a mesh with the gear teeth 61a of the input shaft 61, and the second gear teeth 41b mesh with the first gear teeth 63a of the rear wheel side output shaft 63. In the second switching sleeve 42 in the first transfer state, the first gear teeth 42a mesh with the gear teeth 52a of the second rotating member 52, and the second gear teeth 42b mesh with the gear teeth 65a of the transfer member 65. In the fourth drive state, the rotational differential between the front propeller shaft 13 and the rear propeller shaft 14 is restricted.

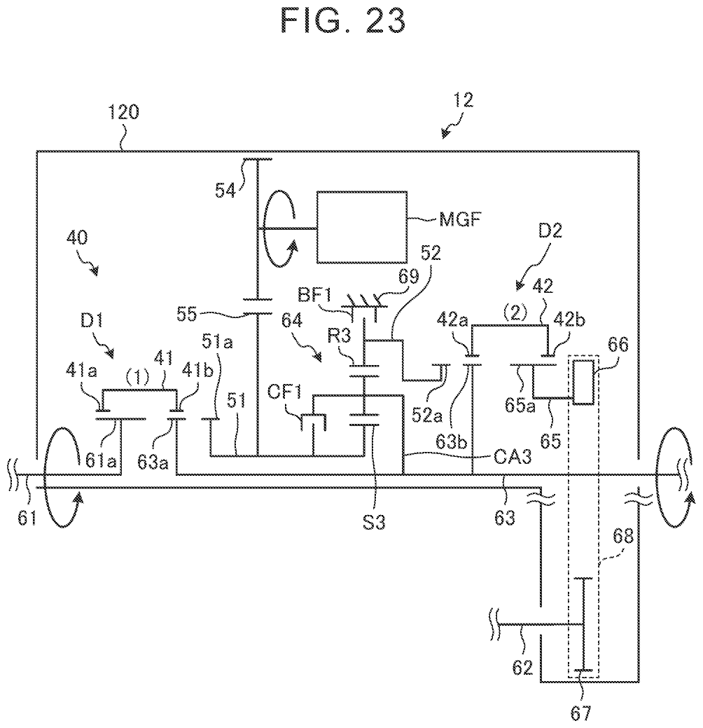

FIG. 23 is a skeleton diagram showing a case where the transfer 12 according to the second embodiment is in the fifth drive state. The fifth drive state is a drive state in a mode in which the power transferred to the transfer 12 in the H4_Lock mode (fixed distribution 4WD) is distributed to the front wheel 3 side and the rear wheel 4 side to cause the vehicle 1 to travel, and is also in the four-wheel drive state in which the power is transferred to the front wheels 3 and the rear wheels 4. The distribution ratio of the power transferred to the front wheel 3 side and the rear wheel 4 side is fixed. Note that, in the fifth drive state, the transfer 12 is set to the high-speed side shift stage Hi.

When the transfer 12 is in the fifth drive state, as shown in FIG. 19, the brake BF1 is disengaged, the clutch CF1 is disengaged, the first dog clutch D1 is in the first input state (1), and the second dog clutch D2 is in the second transfer state. Note that, (1) in the first dog clutch D1 in FIG. 23 indicates that the first dog clutch D1 is in the first input state. Further, (2) in the second dog clutch D2 in FIG. 23 indicates that the second dog clutch D2 is in the second transfer state. In the first switching sleeve 41 in the first input state, the first gear teeth 41a mesh with the gear teeth 61a of the input shaft 61, and the second gear teeth 41b mesh with the first gear teeth 63a of the rear wheel side output shaft 63. Further, in the second switching sleeve 42 in the second transfer state, the first gear teeth 42a mesh with the second gear teeth 63b of the rear wheel side output shaft 63, and the second gear teeth 42b mesh with the gear teeth 65a of the transfer member 65. As described above, in the fifth drive state, the input shaft 61 is connected to the rear wheel side output shaft 63 by the first dog clutch D1, and the rear wheel side output shaft 63 is connected to the transfer member 65 by the second dog clutch D2. Further, in the fifth drive state, the rotational differential between the front propeller shaft 13 and the rear propeller shaft 14 is disabled.

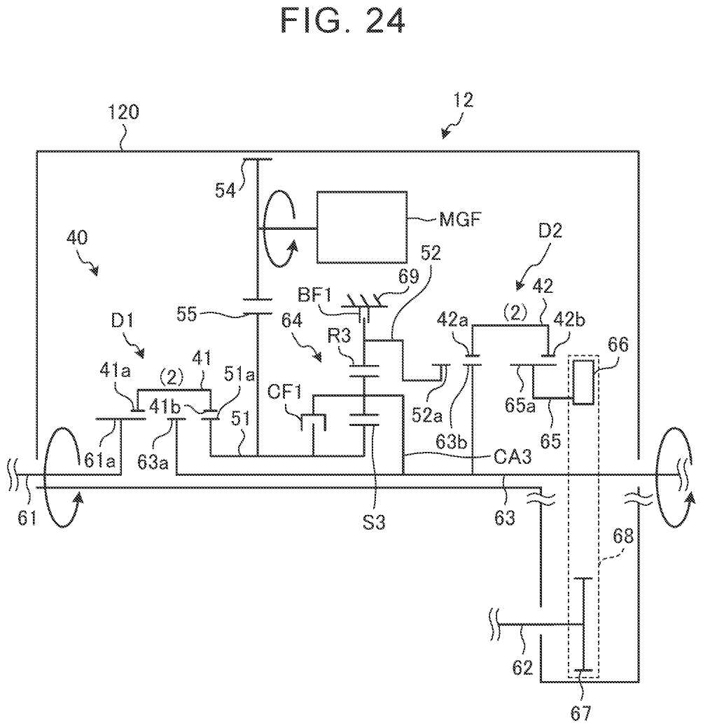

FIG. 24 is a skeleton diagram showing a case where the transfer 12 according to the second embodiment is in the sixth drive state. The sixth drive state is a drive state in a mode in which the power transferred to the transfer 12 in the L4_Lock mode (fixed distribution 4WD) is distributed to the front wheel 3 side and the rear wheel 4 side to cause the vehicle 1 to travel, and is also in the four-wheel drive state in which the power is transferred to the front wheels 3 and the rear wheels 4. The distribution ratio of the power transferred to the front wheel 3 side and the rear wheel 4 side is fixed. In the sixth drive state, the transfer 12 is set to the low-speed side shift stage Lo.

When the transfer 12 is in the sixth drive state, as shown in FIG. 19, the brake BF1 is engaged, the clutch CF1 is disengaged, the first dog clutch D1 is in the second input state, and the second dog clutch D2 is in the second transfer state. Note that, (2) in the first dog clutch D1 in FIG. 24 indicates that the first dog clutch D1 is in the second input state. Further, (2) in the second dog clutch D2 in FIG. 24 indicates that the second dog clutch D2 is in the second transfer state. In the first switching sleeve 41 in the second input state, the first gear teeth 41a mesh with the gear teeth 61a of the input shaft 61, and the second gear teeth 41b mesh with the gear teeth 51a of the first rotating member 51. Further, in the second switching sleeve 42 in the second transfer state, the first gear teeth 42a mesh with the second gear teeth 63b of the rear wheel side output shaft 63, and the second gear teeth 42b mesh with the gear teeth 65a of the transfer member 65. As described above, in the sixth drive state, the input shaft 61 is connected to the first rotating member 51 by the first dog clutch D1, and the rear wheel side output shaft 63 is connected to the transfer member 65 by the second dog clutch D2. Further, in the sixth drive state, the rotational differential between the front propeller shaft 13 and the rear propeller shaft 14 is disabled.

Then, in the drive device 10 according to the second embodiment, various controls to be executed by the electronic control device 100 described in the first embodiment using FIGS. 15 and 16 and the like can be implemented. At this time, the EV(FF)_Hi mode and the EV(FF)_Lo mode in the first embodiment may be replaced with the EV(FR)_Hi mode and the EV(FR)_Lo mode.

For example, similar to the configuration that has been described in the first embodiment with reference to FIGS. 15 and 16 and the like, in the vehicle 1 provided with the drive device 10 according to the second embodiment, the electronic control device 100 controls the MGF torque from the third rotating electric machine MGF so as to change the torque distribution ratio at which the torque from the input shaft 61 is distributed to the front wheel side output shaft 62 and the rear wheel side output shaft 63. When the MGF torque from the third rotating electric machine MGF is limited and thus the change of the torque distribution ratio is restricted, the electronic control device 100 changes the torque distribution ratio by controlling the torque capacity of the clutch CF1.

Accordingly, with the drive device 10 according to the second embodiment, even when the MGF torque from the third rotating electric machine MGF is limited, and the change of the torque distribution ratio at which the torque is distributed to the front wheel side output shaft 62 and the rear wheel side output shaft 63 is restricted, the torque distribution ratio can be appropriately changed by controlling the torque capacity of the clutch CF1.

Note that, in the first embodiment and the second embodiment, when the MGF torque from the third rotating electric machine MGF is limited and the torque distribution ratio on the rear wheel 4 side cannot be changed to the required torque distribution ratio, the electronic control device 100 controls the torque capacity of the clutch CF1 as a substitute for the change of the torque distribution ratio on the rear wheel 4 side. However, the electronic control device 100 may control the torque capacity of the clutch CF1 as a substitute for the change of the torque distribution ratio on the rear wheel 4 side when the MGF torque from the third rotating electric machine MGF is limited, regardless of whether the torque distribution ratio on the rear wheel 4 side can be changed to the required torque distribution ratio.

Further, in the first embodiment and the second embodiment, the transfer 12 includes the brake BF1, the first dog clutch D1, and the second dog clutch D2 in addition to the clutch CF1 so as to realize the first drive state to the sixth drive state. However, the brake BF1, the first dog clutch D1, and the second dog clutch D2 may be omitted. In this case, in the first embodiment, the input shaft 61 and the rear wheel side output shaft 63 are constantly connected to each other, and the rear wheel side output shaft 63 and the ring gear R3 are constantly connected to each other. In the second embodiment, the input shaft 61 and the rear wheel side output shaft 63 are constantly connected to each other, and the front wheel side output shaft 62 and the ring gear R3 are constantly connected to each other.

Further, in the first embodiment and the second embodiment, the clutch CF1 engages the carrier CA3 with the sun gear S3. However, the clutch CF1 may engage the carrier CA3 with the ring gear R3, or may engage the sun gear S3 with the ring gear R3.

What is claimed is:

1. A vehicle drive device, comprising:
a power source;
a rotating electric machine;
a first output shaft that is connected to the power source and outputs power to one of front wheels and rear wheels;
a second output shaft that outputs power to the other of the front wheels and the rear wheels;
a differential mechanism provided with a first rotating element connected to the first output shaft, a second rotating element connected to the second output shaft, and a third rotating element connected to the rotating electric machine;
an engaging element that selectively engages any two of the first rotating element, the second rotating element, and the third rotating element; and
a control device, wherein the control device is configured to control torque from the rotating electric machine so as to change a torque distribution ratio at which torque from the power source is distributed to the first output shaft and the second output shaft, and to change the torque distribution ratio by controlling a torque capacity of the engaging element when the torque from the rotating electric machine is limited and thus a change of the torque distribution ratio is restricted.

2. The vehicle drive device according to claim 1, wherein the control device is configured to change the torque distribution ratio by controlling the torque capacity of the engaging element when the torque from the rotating electric machine is limited and the torque distribution ratio is not able to be changed to a required torque distribution ratio.

3. The vehicle drive device according to claim 1, wherein:
the first output shaft and the first rotating element may be connected to each other so as to be disconnectable and connectable by a disconnection-connection mechanism, and
the vehicle drive device further includes a fixing element that selectively fixes the first rotating element to a fixing member.

4. The vehicle drive device according to claim 1, wherein:
the second output shaft and the second rotating element are connected to each other so as to be disconnectable and connectable by a disconnection-connection mechanism; and
the vehicle drive device further includes a fixing element that selectively fixes the second rotating element to a fixing member.
